(19) United States
(12) Patent Application Publication
(10) Pub. No.: US 2026/0061573 A1
(43) Pub. Date: Mar. 5, 2026

(54) APPARATUS AND METHOD FOR ASSEMBLING AND/OR REPAIRING MACHINES

(71) Applicant: RTX CORPORATION, Farmington, CT (US)

(72) Inventors: Zachary Hunter SEARS, Moodus, CT (US); Malick D. KELLY, III, Rocky Hill, CT (US)

(73) Assignee: RTX CORPORATION, Farmington, CT (US)

(21) Appl. No.: 19/314,162

(22) Filed: Aug. 29, 2025

Related U.S. Application Data
(60) Provisional application No. 63/689,577, filed on Aug. 30, 2024.

(51) Int. Cl. B25B 21/00; F01D 25/00

(52) U.S. Cl. CPC B25B 21/002; F01D 25/00; F05D 2230/60; F05D 2230/80

(57) ABSTRACT

A deep reach torque system comprises a modular rail assembly designed to receive a flexible, segmented gearbox assembly. The flexible segmented, gearbox assembly comprises an aft gearbox subassembly; a mid-gearbox subassembly; and, a forward gearbox subassembly. A method for installing a part at a blind part location within a machine comprises the steps of deploying a modular rail assembly within a bore of a machine at an intended position therein; deploying a flexible, segmented gearbox assembly on a pair of tracks of the modular rail assembly; positioning and aligning the flexible, segmented gearbox assembly with a blind part location; dispensing a part through a tubular-shaped part dispenser to a socket of a drive socket of a forward gearbox subassembly of the flexible, segmented gearbox assembly; and rotatably engaging the part with a blind part until the part is secured on the blind part.

### CROSS REFERENCE TO RELATED APPLICATIONS

This application claims priority to and the benefit of U.S. Provisional Application No. 63/689,577, filed Aug. 30, 2024, the entire contents of which are herein incorporated by reference in their entirety.

### FIELD OF THE INVENTION

The subject matter disclosed herein relates to an apparatus and method for assembling and/or repairing machines and, in particular, to an apparatus and method for assembling and/or repairing gas turbine engines and their associated components.

### BACKGROUND OF THE INVENTION

In the manufacture of aircraft, automotive and other complex mechanical assemblies, the situation often arises where screw fasteners such as bolts, nuts or screws must be torqued in a location which is restricted in access to conventional socket wrench sets, screwdrivers and hand operated box, open end or adjustable wrenches. In certain instances, the factory installs a part and then hinders wrench access to the part by installing structure or other parts in the vicinity of the originally accessible part. Removal, adjustment or reinstallation of the reduced access part becomes a very difficult process and often requires disassembly of structure and/or machinery just to provide wrench access. In other instances, the aircraft, automobile or machine designer by error or oversight did not allow clearance for conventional wrench access to a part that requires maintenance or service.

With respect to the manufacture of aircraft and, specifically, aircraft engines, many rotating components, e.g., high pressure compressors, fans, etc., employ internal bolted joints to fasten stages together. These stages may have flanges on an inner wall of a rotor or drum, for instance, and a comparatively narrow bore where the rotor web terminates. Access to these bolted joints becomes increasingly more difficult as bore diameters decrease, bolt circles increase, and axial web spacing decreases. In addition, maintenance efforts for removal, adjustment or reinstallation may require a rotating component to be accessed from either direction, e.g., horizontal or vertical, can present a long axial distance a tooling must traverse. Moreover, bolted joints require high torques and those high torque values, along with the associated angle(s) of turn, must be measured and recorded throughout any removal, adjustment or reinstallation process.

### SUMMARY OF THE INVENTION

According to an embodiment of the present disclosure, there is provided a deep reach torque system, comprising: a modular rail assembly designed to receive a flexible, segmented gearbox assembly, wherein the flexible segmented, gearbox assembly comprises: an aft gearbox subassembly; a mid-gearbox subassembly; and a forward gearbox subassembly.

In further embodiments of the present disclosure, including further embodiments of the above exemplary embodiments, the modular rail assembly comprises at least one pair of rails having at least one guide track disposed thereon; a tubular-shaped part dispenser disposed in contact with and adjacent to the at least one pair of rails; and a telescoping rotatable axle disposed in contact with and adjacent to the at least one pair of rails and parallel to the tubular-shaped part dispenser.

In further embodiments of the present disclosure, including further embodiments of the above exemplary embodiments, the telescoping rotatable axle includes a rotatable drive gear at a distal end.

In further embodiments of the present disclosure, including further embodiments of the above exemplary embodiments, the modular rail assembly further comprises a spur gear in communication with a chain and sprocket drive.

In further embodiments of the present disclosure, including further embodiments of the above exemplary embodiments, the modular rail assembly further comprises a radial motion gearbox or a gearmotor.

In further embodiments of the present disclosure, including further embodiments of the above exemplary embodiments, the radial motion gearbox comprises a rotatable drive socket disposed in contact with an enclosure housing a radial motion gear train layout comprising at least one pair of driven gears.

In further embodiments of the present disclosure, including further embodiments of the above exemplary embodiments, the radial motion gear train layout comprises a plurality of spur gears disposed in contact with and engaging at least one pair of output spur gears.

In further embodiments of the present disclosure, including further embodiments of the above exemplary embodiments, the at least one pair of driven gears is disposed in contact with and engages at least one pair of gear teeth laterally disposed along a periphery of a bottom surface of the flexible, segmented gearbox assembly.

In further embodiments of the present disclosure, including further embodiments of the above exemplary embodiments, the flexible segmented, gearbox assembly further comprises a cable; and a tension band, wherein the aft gearbox subassembly is disposed in connection with the mid-gearbox subassembly, the mid-gearbox subassembly is disposed in connection with forward gearbox subassembly positioned opposite the aft gearbox subassembly, and the cable and the tension band are disposed in connection with the aft gearbox subassembly, the mid-gearbox subassembly, and the forward gearbox subassembly.

In further embodiments of the present disclosure, including further embodiments of the above exemplary embodiments, the aft gearbox subassembly comprises a tension linkage assembly disposed in contact with the tension band and a bearing support housing a plain bearing capable of receiving a drive gear and permitting the drive gear to rotate therein.

In further embodiments of the present disclosure, including further embodiments of the above exemplary embodiments, the mid-gearbox subassembly comprises at least one mid-gearbox segment and houses a gear train layout.

In further embodiments of the present disclosure, including further embodiments of the above exemplary embodiments, the gear train layout comprises a plurality of input gears and a plurality of output gears, the plurality of input gears comprise a drive gear and at least one pair of idler gears, the plurality of output gears comprise at least one common gear, an encoder idler gear, and a driven gear, the drive gear and the driven gear are disposed opposite each other and the at least one pair of idler gears, at least one common gear and the encoder idler gear are disposed between the drive gear and the driven gear, at least one tooth of the drive gear engages at least one idler tooth of the at least one pair of idler gears, the at least one idler tooth of the at least one pair of idler gears engages at least one common tooth of at least one common gear or at least one encoder tooth of the encoder idler gear or both at least one common tooth of at least one common gear and at least one encoder tooth of the encoder idler gear, and the at least one idler tooth of the at least one pair of idler gears engages at least one tooth of the driven gear.

According to another embodiment of the present disclosure, there is provided to a method for installing a part at a blind part location within a machine, comprising the steps of deploying a modular rail assembly within a bore of a machine at an intended position therein; deploying a flexible, segmented gearbox assembly on at least one pair of tracks of the modular rail assembly; positioning and aligning the flexible, segmented gearbox assembly with at least one blind part location; dispensing at least one part through a tubular-shaped part dispenser to a socket of a drive socket of a forward gearbox subassembly of the flexible, segmented gearbox assembly; and rotatably engaging the at least one part with at least one blind part until the at least one part is secured on the at least one blind part.

In further embodiments of the present disclosure, including further embodiments of the above exemplary embodiments, further comprising repeating, until the at least one part is secured to each blind part, the following steps: positioning and aligning flexible, segmented gearbox assembly with the next at least one blind part location; locking the flexible, segmented gearbox assembly; dispensing the at least one part through the tubular-shaped part dispenser to the socket of the drive socket of the forward gearbox subassembly of the flexible, segmented gearbox assembly; raising the flexible, segmented gearbox assembly to elevate the at least one part in a −z direction and contact the at least one blind part; rotatably engaging the at least one part with the at least one blind part until the at least one part is secured; disengaging and lowering the flexible, segmented gearbox subassembly in a +z direction; and rotating the modular rail assembly, and the flexible, segmented gearbox assembly disposed thereupon, until aligning the at least one pair of tracks with the next at least one blind part location.

In further embodiments of the present disclosure, including further embodiments of the above exemplary embodiments, prior to deploying the flexible, segmented gearbox assembly, rotatably extending at least one additional pair of tracks of the modular rail assembly using a spur gear in communication with a chain and sprocket drive.

In further embodiments of the present disclosure, including further embodiments of the above exemplary embodiments, after deploying the modular rail assembly, further comprising the step of unlocking a flexible, segmented gearbox assembly.

In further embodiments of the present disclosure, including further embodiments of the above exemplary embodiments, after deploying the flexible, segmented gearbox assembly on the modular rail, further comprising the step of deploying further the flexible, segmented gearbox assembly until achieving a reach distance.

In further embodiments of the present disclosure, including further embodiments of the above exemplary embodiments, after positioning and aligning the flexible, segmented gearbox assembly, further comprising the step of locking the flexible, segmented gearbox assembly.

In further embodiments of the present disclosure, including further embodiments of the above exemplary embodiments, after locking the flexible, segmented gearbox assembly, further comprising raising the flexible, segmented gearbox assembly to elevate the part in a −z direction and contact at least one blind part at the at least one blind part location.

In further embodiments of the present disclosure, including further embodiments of the above exemplary embodiments, after locking the flexible, segmented gearbox assembly, further comprising the steps of lowering a rotatable drive gear of a telescoping rotatable axis in a +z direction; engaging a rotatable drive socket of a radial motion gearbox or a gearmotor of the modular rail assembly and moving the flexible, segmented gearbox assembly in a −y direction along the at least one pair of tracks and at least one pair of additional tracks; and rotating the modular rail assembly, and the flexible, segmented gearbox assembly disposed thereupon, until aligning the at least one pair of tracks and at least one pair of additional tracks with the next at least one blind part location.

In further embodiments of the present disclosure, including further embodiments of the above exemplary embodiments, further comprising the step of raising the flexible, segmented gearbox assembly to elevate the part in a −z direction and contact the next at least one blind part at the next at least one blind part location.

In further embodiments of the present disclosure, including further embodiments of the above exemplary embodiments, after dispensing the at least one part, further comprising the step of engaging a rotatable drive socket of a radial motion gearbox or a gearmotor of the modular rail assembly and moving the flexible, segmented gearbox assembly in a +y direction.

In further embodiments of the present disclosure, including further embodiments of the above exemplary embodiments, after rotatably engaging, further comprising the step of disengaging and lowering the flexible, segmented gearbox assembly in a +z direction.

In further embodiments of the present disclosure, including further embodiments of the above exemplary embodiments, after disengaging and lowering the flexible, segmented gearbox assembly, further comprising the step of engaging a rotatable drive socket of a radial motion gearbox or a gearmotor of the modular rail assembly and moving the flexible, segmented gearbox assembly in a −y direction.

In further embodiments of the present disclosure, including further embodiments of the above exemplary embodiments, further comprising rotating the modular rail assembly, and the flexible, segmented gearbox assembly disposed thereupon, until aligning the at least one pair of tracks with the next at least one blind part location.

In further embodiments of the present disclosure, including further embodiments of the above exemplary embodiments, after rotating the modular rail assembly, further comprising the steps of dispensing a part through the tubular-shaped part dispenser to the socket of the drive socket of the forward gearbox subassembly of the flexible, segmented gearbox assembly; and engaging a rotatable drive socket of a radial motion gearbox of the modular rail assembly and moving the flexible, segmented gearbox assembly in the +y direction.

In further embodiments of the present disclosure, including further embodiments of the above exemplary embodiments, after unlocking the flexible, segmented gearbox assembly, further comprising the steps of engaging a rotatable drive socket of a radial motion gearbox or a gearmotor of the modular rail assembly and moving the flexible, segmented gearbox assembly in the −y direction along the at least one pair of additional tracks and the at least one pair of tracks of the modular rail assembly; and moving the flexible segmented gearbox assembly in the −z direction along the at least one pair of tracks of the modular rail assembly.

In further embodiments of the present disclosure, including further embodiments of the above exemplary embodiments, the machine comprises a gas turbine engine comprising at least one gas turbine engine component.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is an illustration of an exemplary flexible, segmented gearbox assembly of a deep reach torque system.

FIG. 2 is an illustration of an underside of the flexible, segmented gearbox assembly of FIG. 1.

FIG. 3 is another illustration of the underside of the flexible, segmented gearbox assembly of FIG. 1.

FIG. 4 is an illustration of an exemplary flexible aft gearbox subassembly of FIG. 1.

FIG. 5 is an illustration of a cross-section of the flexible aft gearbox subassembly of FIG. 4.

FIG. 6 is an illustration of a cross-section of an exemplary flexible common middle gearbox segment of FIG. 1.

FIG. 7 is an illustration of an exemplary gear train layout.

FIG. 8 is an illustration of an exemplary flexible forward gearbox subassembly of FIG. 1.

FIG. 9 is a cross-sectional view of the flexible forward gearbox subassembly of FIG. 8.

FIG. 10 is an illustration of the flexible, segmented gearbox assembly of FIG. 1 deployed on an exemplary modular rail assembly.

FIG. 11 is another illustration of the flexible, segmented gearbox assembly deployed on the modular rail assembly of FIG. 10 and a frame of reference.

FIG. 12 is a top view of an exemplary turbine engine component having a bore and a blind part disposed therein.

FIG. 13 is a first of four illustrations depicting a flowchart for an exemplary method for assembling and/or repairing a gas turbine engine component.

FIG. 14 is a second of four illustrations depicting the flowchart of FIG. 13.

FIG. 15 is a third of four illustrations depicting the flowchart of FIG. 13.

FIG. 16 is a fourth of four illustrations depicting the flowchart of FIG. 13.

FIG. 17 is an illustration of a step 1000 of the flowchart of FIG. 13 and a frame of reference.

FIG. 18 is an illustration of a step 1100 of the flowchart of FIG. 13 and frame of reference.

FIG. 19 is an illustration of a step 1200 of the flowchart of FIG. 13 and frame of reference.

FIG. 20 is an illustration of a step 1300 of the flowchart of FIG. 13 and frame of reference.

FIG. 21 is an illustration of a step 1400 of the flowchart of FIG. 13 and frame of reference.

FIG. 22 is an illustration of a step 1500 of the flowchart of FIG. 13 and frame of reference.

FIG. 23 is an illustration of steps 1600 and 1700 of the flowchart of FIG. 14 and frame of reference.

FIG. 24 is an illustration of a step 1800 of the flowchart of FIG. 14 and frame of reference.

FIG. 25 is an illustration of a step 1900 of the flowchart of FIG. 14 and frame of reference.

FIG. 26 is an illustration of a step 2000 of the flowchart of FIG. 14 and frame of reference.

FIG. 27 is an illustration of a step 2100 of the flowchart of FIG. 14 and frame of reference.

FIG. 28 is an illustration of a step 2200 of the flowchart of FIG. 15 and frame of reference.

FIG. 29 is an illustration of a step 2300 of the flowchart of FIG. 15 and frame of reference.

FIG. 30 is an illustration of a step 2400 of the flowchart of FIG. 15 and frame of reference.

FIG. 31 is an illustration of a step 2500 of the flowchart of FIG. 15 and frame of reference.

FIG. 32 is an illustration of a step 2600 of the flowchart of FIG. 15 and frame of reference.

FIG. 33 is an illustration of a step 2700 of the flowchart of FIG. 15 and frame of reference.

FIG. 34 is an illustration of a step 2800 of the flowchart of FIG. 16 and frame of reference.

FIG. 35 is an illustration of a step 2900 of the flowchart of FIG. 16 and frame of reference.

FIG. 36 is an illustration of a step 3000 of the flowchart of FIG. 16 and frame of reference.

FIG. 37 is an illustration of a step 3100 of the flowchart of FIG. 16 and frame of reference.

FIG. 38 is an illustration of steps 3200 and 3300 of the flowchart of FIG. 16 and frame of reference.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

The present disclosure is directed to an exemplary apparatus and method for assembling and/or repairing gas turbine engines and, in particular, gas turbine engine components possessing small-bore diameter(s) and having blind parts disposed therein at a deep axial distance coupled with low axial web spacing and a long reach part location-to-bore diameter ratio(s). The apparatus and method permits much greater radial reach while operating in a smaller bore size with minimal axial web spacing. And, the ability to operate in a smaller bore size with minimal axial web spacing leads to optimized rotor mass efficiency.

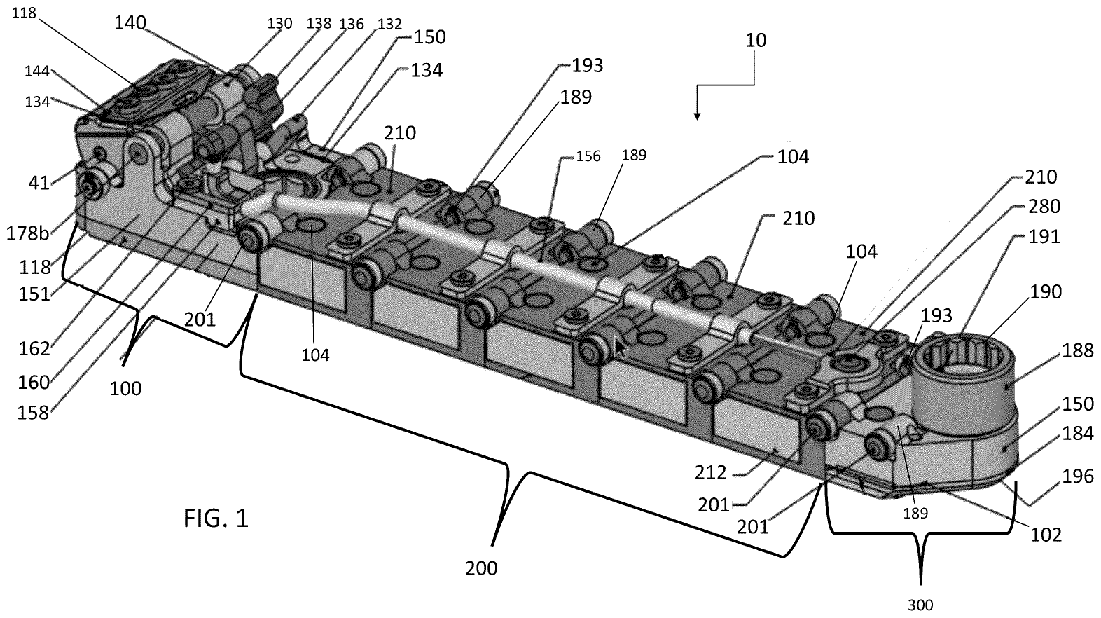

Referring to FIGS. 1-3, the apparatus for assembling and/or repairing gas turbine engines and related gas turbine engine components, also known as a deep reach torque system, that includes an exemplary flexible, segmented gearbox assembly 10 and an exemplary modular rail assembly 50. The flexible, segmented gearbox assembly 10 includes an exemplary flexible aft gearbox subassembly 100 connected to at least one exemplary flexible mid-gearbox subassembly 200 that is also connected to an exemplary flexible forward gearbox subassembly 300 positioned opposite the flexible aft gearbox subassembly 100 (See FIGS. 1-3). The flexible aft gearbox subassembly 100, flexible mid-gearbox subassembly 200, and flexible forward gearbox subassembly 300 may be connected in part by a tension band 102 (See FIGS. 1-3).

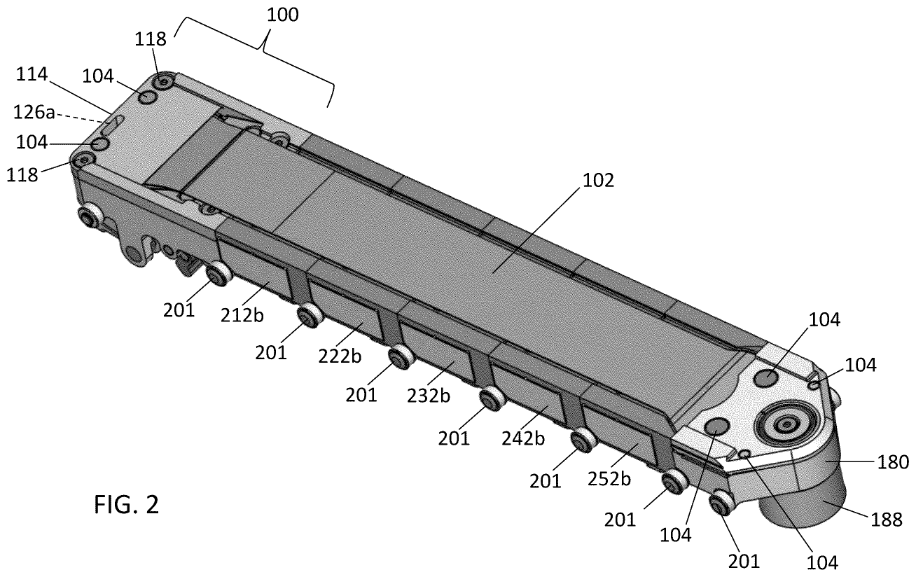

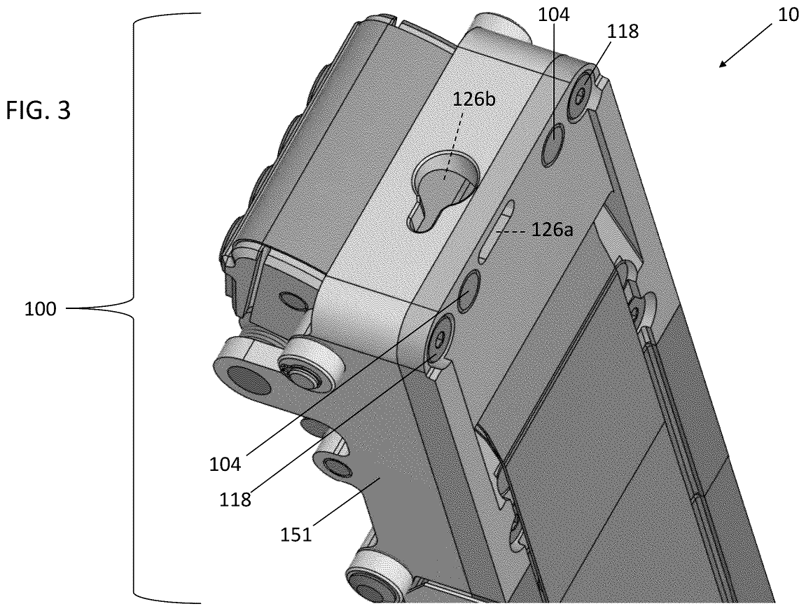

Looking at the underside of the flexible, segmented gearbox assembly 10, the tension band 102 may be secured by at least one dowel pin 104 at the flexible aft gearbox subassembly 100 and may extend across the entire flexible mid-gearbox subassembly 200 until reaching a cover 112 of the flexible forward gearbox subassembly 300 (See FIG. 2). Although not shown, a plurality of gear rack teeth may be disposed alongside each edge proximate to and opposing the left and right sides of the bottom of each subassembly 100, 200, 300 to facilitate the flexible, segmented gearbox assembly 10 ability to translate forward and aft motion along the tracks 467 and additional tracks 480. The tension band 102 may be inserted within and proximate to the cover 112 and may extend further until engaging the clamp plate 144 of the tension linkage assembly 130 (See FIGS. 1 and 2). At the edge 114, at least one dowel pin 108 may secure the cover 112 to the flexible forward gearbox subassembly 300 (See FIGS. 1 and 2). At the opposing end of the flexible, segmented gearbox assembly 10, the tension band 102 may be inserted within and proximate to a case 150 of the flexible aft gearbox subassembly 100 (See FIG. 3). The flexible aft gearbox subassembly 100 also includes a keyhole aperture 126a, 126b designed to accept and/or receive a bayonet type feature for gearbox installation and removal (not shown) to and from the modular rail assembly 50 for deployment into a gas turbine engine and gas turbine engine component (See FIG. 3).

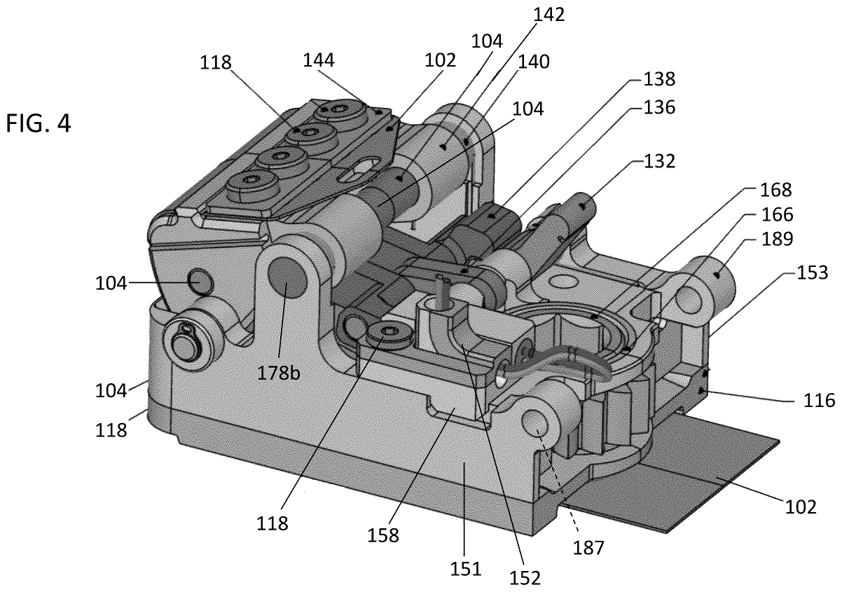

Referring now to FIGS. 1 and 3-5, the flexible aft gearbox subassembly 100 is illustrated with a tension linkage assembly 130 in a locked position. The flexible aft gearbox subassembly 100 includes the case 150 having at least one pair of hinge knuckles 189 integrally formed therein through which at least one guide pin 201 may be inserted therethrough. The case 150, having at least one side wall 151 may house a precision limit switch 152 (See FIG. 4) disposed within and in contact with a cable clamp 154 through which a cable 156 may be disposed within a hollow tubular-shaped structure, e.g., a hollow tubing 157 (See FIG. 4). An electrical signal (not shown) may be transmitted via the cable 156 disposed within the tubing 157 and received by, e.g., a magnetic rotary encoder 280 and a magnet 278, to relay angular position information to a data recording device (not shown) while actuating additional parts, e.g., raising the subassembly 300 in the −z direction.

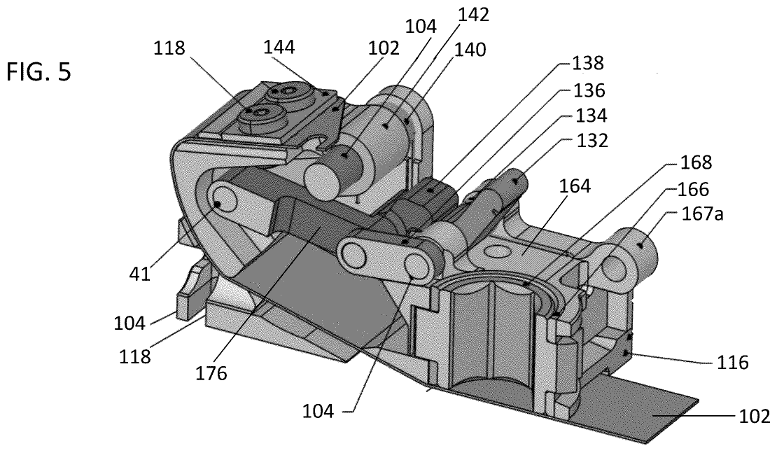

The precision limit switch 152 and cable clamp 154 may be positioned adjacent to and in contact with the side wall 151 (See FIG. 4). The cable clamp 154 may comprise a base 158 disposed in contact with the case 150 and secured together by screw 118 (See FIG. 4). Disposed between the side walls 151 and adjacent the precision limit switch 152 and cable clamp 154, a bearing support 164 may be disposed therein (See FIGS. 4 and 5). More specifically, the bearing support 164 may be positioned centrally between side walls 151 (See FIGS. 4 and 5). The bearing support 164 may house a plain bearing 166 (See FIGS. 4 and 5). The plain bearing 166 may be designed to receive and permit a drive gear 168 to rotate therein (See FIGS. 4 and 5). Any suitable material for use as a drive gear may be utilized. At least one suitable material may include, but is not limited to, high strength steel alloys, e.g., maraging steel, with friction reducing coatings, that may permit high torque operation at low speeds.

Also disposed between the side walls 151 a tension linkage assembly 130 may be positioned within and adjacent to a rear wall 155 of the case 150 opposite bearing support 164 (See FIGS. 4 and 5). The tension linkage 130 may include a release 132, a crank 136, a connecting rod 138, at least one torsion spring 140, a rocker 142, and a clamp plate 144 (See FIGS. 4 and 5). As mentioned above, the tension band 102 may be inserted within and proximate to the case 150 and may extend further until engaging the clamp plate 144 of the tension linkage assembly 130 (See FIGS. 4 and 5). At least one screw 118, may secure the tension band 102 to the clamp plate 144. Although illustrated in the locked position, once actuated, the release 132 disengages and permits the torsion spring 140 to rotate about a dowel pin 104 inserted therethrough and rotatably engage the connecting rod 138 (See FIGS. 4 and 5). The connecting rod motion may rotate the crank 136 about the dowel pin 104. On an opposing end of the crank 136, the connecting rod 138 may be inserted therethrough and rotatably engage the crank 136 (See FIGS. 4 and 5). An arm 176 of the connecting rod 138 extends until rotatably engaging the dowel pin 104 inserted therethrough and connects to the rocker 142 also inserted therethrough by the dowel pin 104 (See FIGS. 4 and 5). Above the insertion point by the dowel 104, the rocker 142 may be secured by the screws 118 to the tension band 102. On an opposing end, the rocker 142 rotatably engages the torsion spring 140 by one dowel pin 178 inserted therethrough (See FIGS. 4 and 5). Using the tension band 102, the tension linkage 130 may actuate movement of the flexible mid-gearbox subassembly 200 and flexible forward gearbox subassembly 300 in a linear direction.

Referring to FIGS. 1, 6 and 7, the flexible mid-gearbox subassembly 200 may include at least one exemplary flexible mid-gearbox segments 210, 220, 230, 240, 250. The flexible mid-gearbox segment 210 adjacent to the aft gearbox subassembly 100 may also be known as the aft mid-gearbox segment 210. At the opposing end, the flexible mid-gearbox segment 250 adjacent to the flexible forward gearbox subassembly 300 may also be known as the forward mid-gearbox segment 250. Disposed therebetween the aft mid-gearbox segment 210 and forward mid-gearbox segment 250 of the flexible mid-gearbox subassembly 200 are the mid-gearbox segments 220, 230, 240. The mid-gearbox segments 220, 230, 240 may also be known as the flexible common mid-gearbox segments 220, 230, 240.

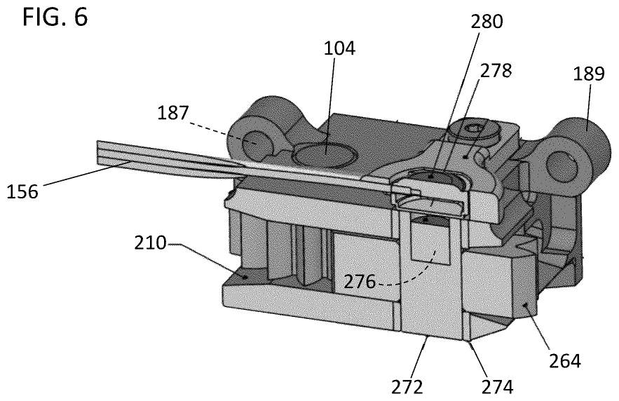

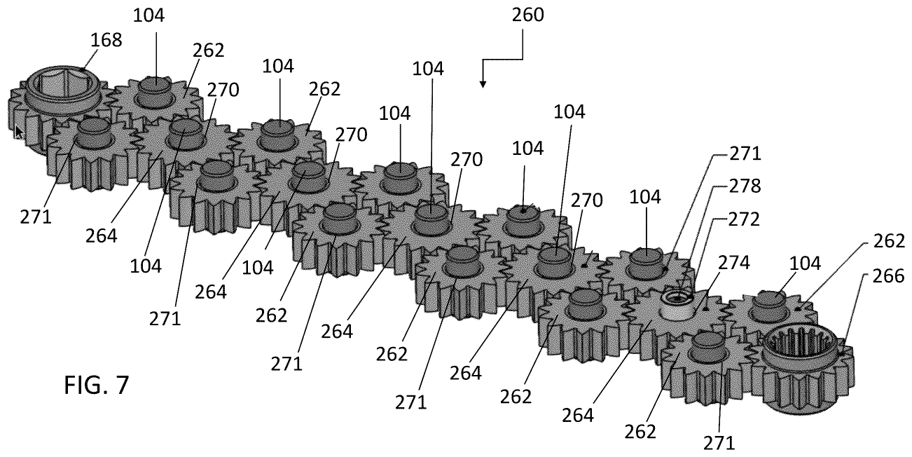

Referring to FIGS. 6 and 7, each flexible mid-gearbox segment 210, 220, 230, 240, 250 may comprise the case 150 serving as an enclosure and having at least one shield 212 also known as a foreign object damage or FOD shield secured on each side thereof. Each shield 212 of each flexible mid-gearbox segment 210, 220, 230, 240, 250 may be secured in place by at least two tack welds per long edge. Each flexible mid-gearbox segment 210, 220, 230, 240, 250 may include at least one pair of hinge knuckles 189 that are integrally formed with each case 150. At least one guide pin 201 may be inserted through each hinge knuckle 189 to act as pin joints and permit rotatable hinged connection with each segment 210, 220, 230, 240, 250. Each guide pin 201 also may be retained using a retaining ring 193.

Housed within the entire subassembly 200, an exemplary gear train layout 260 may be positioned within each flexible mid-gearbox segment 210, 220, 230, 240, 250 (See FIG. 7). The gear train layout 260 may comprise a series of dual idler gears having an input gear 168, pairs of idler gears 262, a combination of common and encoder single idler gears 264, and an output gear266. (See FIG. 7). The teeth of each pair of idler gears 262 may mesh with the teeth of each respective common and encoder idler gear 264 positioned between each pair (See FIG. 7). When the drive gear 168 is engaged, the teeth of the drive gear 168 mesh with the teeth of each pair of idler gears 262, thus engaging each pair of idler gears 262 (See FIG. 7). Each respective common and encoder idler gear 264 thus ultimately engage the driven gear 266 (See FIGS. 6 and 7). Each idler gear 262 and common idler gear 264 may be secured in place by dowel pins 104 inserted within the centrally located apertures of at least one plain bearing 270 and of at least one plain bearing 271 centrally disposed within a centrally located aperture of each gear 262 respectively (See FIGS. 6 and 7). The encoder idler gear 264 may be secured by an encoder pin 272 inserted within a centrally located aperture of a plain bearing 274 (See FIGS. 6 and 7). The encoder pin 272 also includes a central cavity 276 within which a magnet 278 may be disposed (See FIGS. 6 and 7). A magnetic rotary encoder 280 may be disposed within the centrally located aperture of the plain bearing 274, proximate to the magnet 278 and in contact with the encoder pin 272 (See FIGS. 6 and 7).

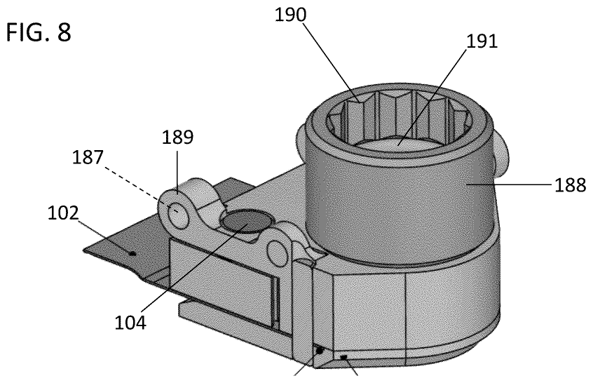

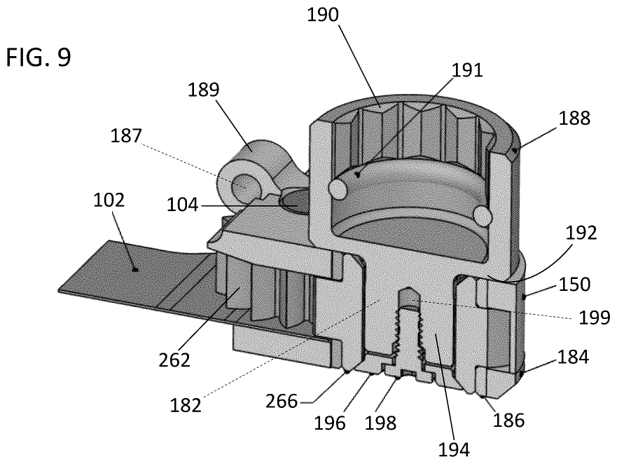

Next, referring to FIGS. 1, 8 and 9, the flexible forward gearbox subassembly 300 may include the case 150 having an aperture 182 and may be secured to a cover 184 that may serve as a base and also may define a lower portion of aperture 182. The flexible forward gearbox subassembly 300 also may include at least one pair of hinge knuckles 189 and at least one set of guide pin holes 187 through which at least one guide pin 201 may be inserted. A plain bearing 186 may be centrally disposed within the aperture 182. The driven gear 266 may be centrally disposed within and adjacent to the plain bearing 186. A drive socket 188 may comprise a socket 190 circumferentially disposed on a base defining an exterior collar 192 having a stem 194 extending downwardly therefrom. Within the socket 190, an O-ring 191 may be concentrically disposed adjacent an interior surface of the socket 190. The O-ring 191 may facilitate securing a part, e.g., a nut, therein for carrying out assembly or repair during use. The drive socket 188 may be centrally disposed within and adjacent to the driven gear 266 until the stem 194 may contact a socket retaining washer 196. Both the stem 194 and socket retaining washer 196 may be secured together using a screw 198 threadingly disposed within a cavity 199 centrally located within the stem 194, which also may secure the drive socket 188 within the driven gear 266.

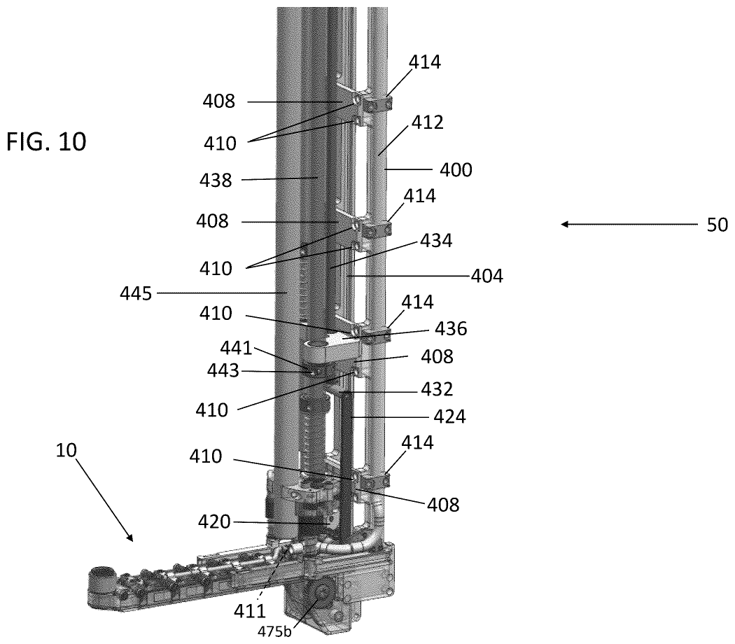

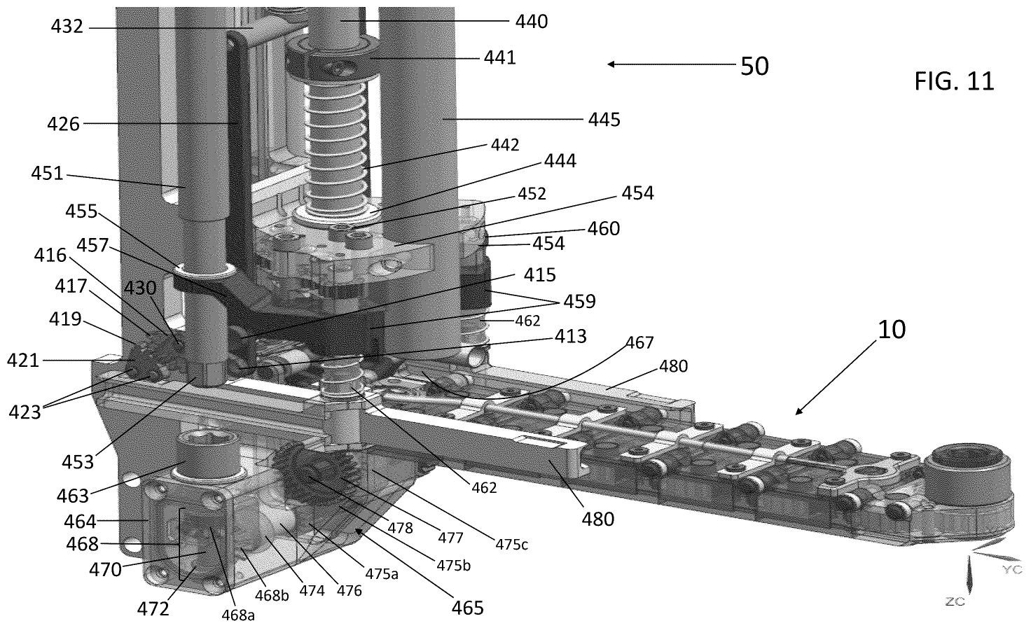

Referring now to FIGS. 10 and 11, the flexible, segmented gearbox assembly 10 is shown in a locked position. The modular rail assembly 50 may include at least one pair of rails 400 whose interior surfaces comprise at least one guide track 404 upon which the flexible, segmented gearbox assembly 10 is disposed. The pair of rails 400 may be secured in place by a plurality of brackets 408 (See FIG. 10). Each bracket 408 may be secured in place by at least two screws 410 (See FIG. 10). At least one guide track 404 may have an exterior surface having a hollow tube 412 disposed adjacent thereto and secured by a plurality of brackets 414 (See FIG. 10). The hollow tube 412 may serve as a device for housing any suitable monitoring device (not shown) for monitoring the flexible, segmented gearbox assembly 10 during use. For instance, an optical monitoring device, e.g., a camera (not shown), may be disposed within the hollow tube 412 such that a camera lens (not shown) may occupy an opening 411 of the hollow tube 412 while a wire (not shown) connected to the camera lens may be disposed through the hollow tube 412 (See FIG. 10).

The flexible, segmented gearbox assembly 10 may be shown in a locked position as mentioned above. The locked position may be indicated by the position 413 of at least one input fan-shaped gear 416 having at least one tooth 417 that may mesh with at least one tooth 419 of at least one output fan-shaped gear 421 (See FIG. 11). Each input and output fan-shaped gear 416 and 421, respectively, may be secured to at least one guide track 404 by a dowel pin 428 with retaining rings that permits the input fan-shaped gear 416 to rotate about (See FIG. 11). Each output fan-shaped gear 421 may be rotatably connected to the track changing lever 420 via at least one dowel pin 423. Opposite at least one tooth 417, each rotatable input fan-shaped gear 416 also may include at least one linkage 424 that may be secured to an axle 432 (See FIG. 11). The linkage 424 may rotate the fan-shaped gear 416 and also may actuate the track changing lever 420. These aforementioned gears 416, 421; lever 420; and, linkage 424 may permit the flexible, segmented gearbox assembly 10 to traverse from the vertical (z-axis) track to the horizontal (y-axis) tracks in the unlocked position, and to be fixed to the y-axis track only when the gearbox assembly 10 is in the locked position.

The axle 432 may be actuated upwards or downwards in a longitudinal or +z direction through a connecting rod 434 centrally attached thereto (See FIGS. 10 and 11). The connecting rod 434 may be secured in place by at least one bracket 436 through which the rod 434 is disposed axially therethrough (See FIG. 10). The bracket 436 may be attached to or integral with any one of the plurality of brackets 408 (See FIG. 10). The bracket 436 may extend laterally in the +y direction so that a track extension control rod 438 may also be disposed therethrough (See FIG. 10). The track extension control rod 438 may include at least one shaft collar 441 circumferentially disposed about a point of contact between two rods 443 and prevent axial motion during operation (See FIG. 10). The bracket 436 may also include an exterior semicircular-shaped notch whose surface may act as a guide for drive shaft 440 disposed parallel to the track extension control rod 438 (See FIG. 10).

The drive shaft 440 also may include at least one shaft collar 441 to prevent unwanted axial motion during operation (See FIG. 11). A compression spring 442 may be concentrically disposed about the drive shaft 440, may be secured at a stationary attachment point to a washer 444 also concentrically disposed about the drive shaft 440, and may be secured at a rotatable attachment point to a washer 446 (See FIG. 11). Aligned parallel to the drive shaft 440, a tubular-shaped part dispenser 445 may be positioned and secured in placed within a circular-shaped opening of a clamp (See FIGS. 10 and 11). Disposed opposite the track extension control rod 438 and adjacent the assembly of the connecting rod 434, axle 432, and linkage 424, is a telescoping rotatable axle 451 having a hexagon shaped torque interface 453 at a distal end. The telescoping rotatable axle 451 may be disposed through a washer 455 and arm 457 adjacent thereto. The arm 457 may extend to form a set of guide rails that permit the arm 457 to translate motion in the Z direction and provide a travel limit for the flexible segmented gearbox assembly 10 during operation. The torque interface 453 may engage a rotatable drive socket 463. The rotatable drive socket 463 may engage a radial motion gearbox 465 that may be located below at least one track 467 for accommodating the flexible, segmented gearbox assembly 10.

Both the drive shaft 440 and connecting rod 434 may be disposed through openings of the clamp 450 (See FIG. 10). The clamp 450 may be secured by at least one screw 452a, 452b, 452c to a clamp-shaped housing 454 disposed below and adjacent thereto (See FIG. 11). The clamp-shaped housing 454 may include an exterior semicircular-shaped notch whose surface also may act as a guide for retaining in place tubular-shaped part dispenser 445. The clamp-shaped housing 454 may contain a spur gear in communication with a chain and sprocket drive 460 (See FIG. 11).

Once actuated by the drive shaft 440 in, e.g., a clockwise direction, the chain and sprocket drive 460 may engage the spur gear such that the spur gear rotates in an opposing direction, e.g., counter-clockwise (See FIG. 11). The chain and sprocket drive 460 in communication with the spur gear drives an output spur gear which in turn drives a set of drive shafts 462. One shaft 462 may be directly driven by the track extension control rod 438, while the opposing shaft 462 may be driven by the output spur gear. In turn, the opposing shaft 462 also drives an input sprocket. Once the track extension control rod 438 is actuated, chain and sprocket drive 460 in communication with the spur gear rotates, and both shafts 462 turn in opposite directions. These shafts 462 rotatably extend an additional pair of tracks 480 starting from a −y plane, sweeping laterally across a −x plane to +x plane, and coming to rest in a +y plane. The pair of tracks 480 may also rotatably retract from the +y plane, sweeping laterally across the +x plane to the −x plane, and returning to the original −y direction plane starting point (See FIG. 11).

Referring now to FIG. 11, the radial motion gearbox assembly 465 may include an enclosure 464 that may house the assembly. The radial motion gearbox assembly 465 may include a straight bevel gear assembly comprising a first bevel gear 468a whose at least one tooth may mesh with at least one tooth of a second bevel gear 468b and, in turn, join the first bevel gear 468a and second bevel gear 468b. The first gear 468a may include a drive shaft 470 disposed therethrough from the top of the enclosure 464 to the bottom of the enclosure 464 and may be secured by a bushing 472. The drive shaft 470 may be integrally connected with the rotatable drive socket 463. The second bevel gear 468b may be secured in place by a bushing 474. Both the bevel gear 468b and washer 474 may have a rotatable axle 476 disposed therethrough. Disposed opposite the bevel gear 468b, a spur gear 475a of a spur gear assembly may have the rotatable axle 476 disposed therethrough. The spur gear assembly may comprise at least three spur gears 475a, 475b and 475c whose teeth mesh together. Each spur gear 475b and 475c may have an individual rotatable axle, respectively, (not shown) disposed therethrough a central opening of each gear 475b, 475c. A drive shaft 478 may extend in opposite directions −x and +x through at least one opening in the enclosure 464, as well as central openings of at least one output spur gear 477 respectively. Each driven gear 477 is disposed adjacent opposing exterior sides of the enclosure 464. The output spur gears 477 engage the flexible, segmented gearbox assembly 10 aligned and in contact with the pair tracks 467 such that the gearbox assembly 10 may move in either a +y direction or a −y direction along the tracks 467 and thus also extend along and beyond the tracks 480. In at least one alternative embodiment, the enclosure 464 may house a gearmotor, rather than a combination of the telescoping rotatable axle 451 and radial motion gearbox assembly 465, that engages the output spur gears 477.

Referring to FIGS. 1-11, the combination of the flexible, segmented gearbox assembly 10 and the modular rail assembly 50 may be implemented together, as a deep reach torque system, to assemble and/or a repair turbine engine component possessing a small-bore diameter and having at least one blind part disposed therein at a deep axial distance coupled with a low axial web spacing and a long reach part location-to-bore diameter ratio. When deployed, the assemblage of the hinge knuckles, retaining rings and guide pins of each subassembly 100, 200, 300 permit each segment of the subassemblies 100, 200, 300 to engage one another by at least partially rotating at an angle while also simultaneously engaging the tracks 467 and additional tracks 480a, 480b. As the flexible, segmented gearbox assembly 10 may also move linearly in ±y direction(s) along the tracks 467 and additional tracks 480, each segment of the subassemblies 100, 200, 300 may also move into, e.g., inwardly and upwardly, and out of, e.g., backwardly and downwardly, the ±y−z plane(s) while also simultaneously engaging the tracks 467 and additional tracks 480. The aforementioned combination of linear, rotational and angular motion by each segment of the subassemblies 100, 200, 300 facilitates the “flexible” motion achieved by the flexible, segmented gearbox assembly 10 along the modular rail assembly 50.

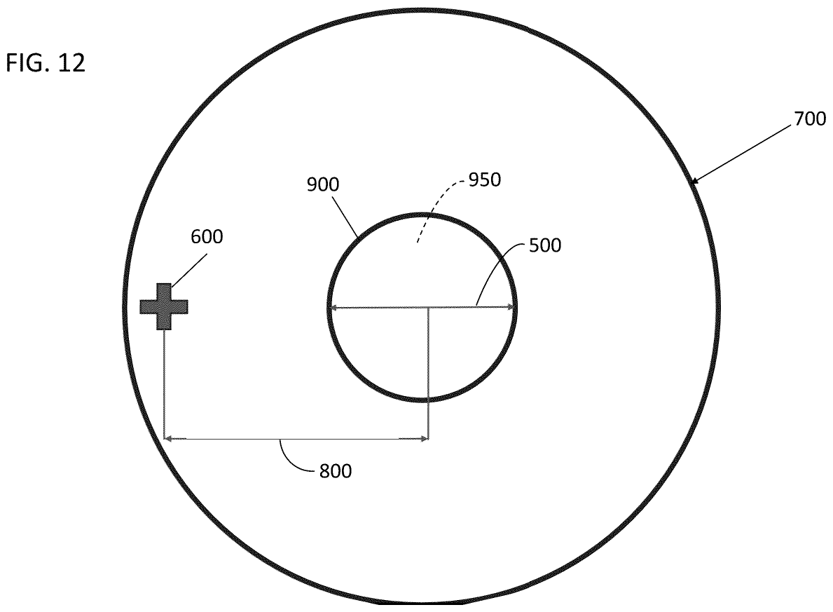

With respect to the aforementioned ratio, FIG. 12 illustrates a bore diameter 500 to a blind part location 600 within a gas turbine engine component 700. The distance between the bore diameter 500 and the blind part location 600 may be referred to as the blind part pattern diameter or the reach 800. When deploying the deep reach torque system, the modular rail assembly 50 may be disposed proximate to an opening 950 of a bore 900 of the gas turbine engine component 700 through which the flexible, segmented gearbox assembly 10 enters. The bore diameter 500 may exhibit and possess a size wide enough to accept and accommodate both the modular rail assembly 50 and the flexible, segmented gearbox assembly 10. Once deployed within the bore 900, the modular rail assembly 50 may extend a distance, vertically or horizontally, sufficient to extend the flexible, segmented gearbox assembly 10 and span the reach 800 proximate to the blind part location 600 within the gas turbine engine component 700. By spanning the reach 800 proximate to the blind part location 600, the flexible, segmented gearbox assembly 10 may engage a blind part 600, e.g., a bolt 600, and either assemble or repair or both assemble and repair the gas turbine engine component 700.

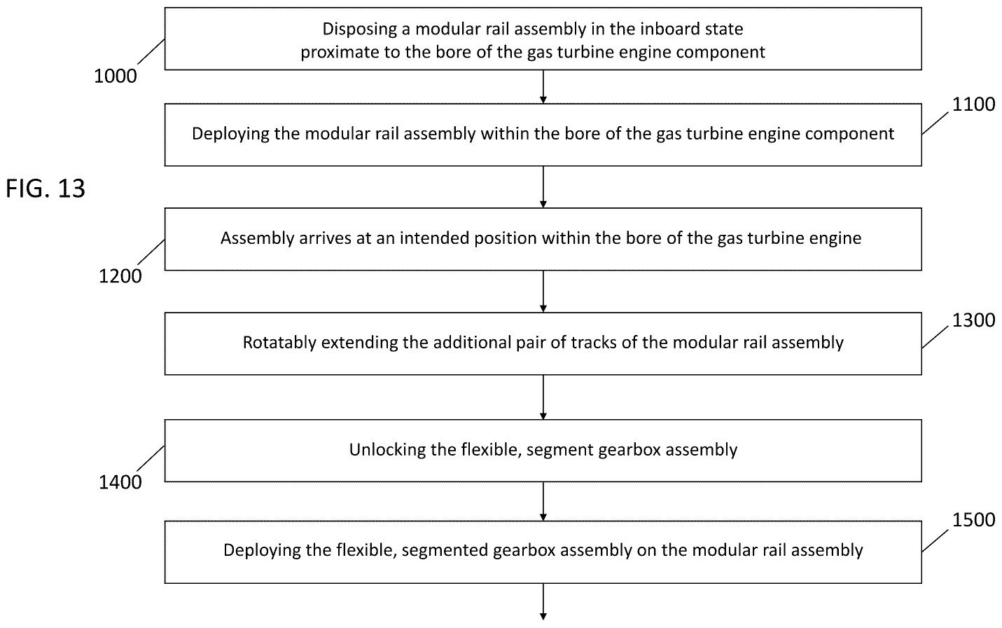

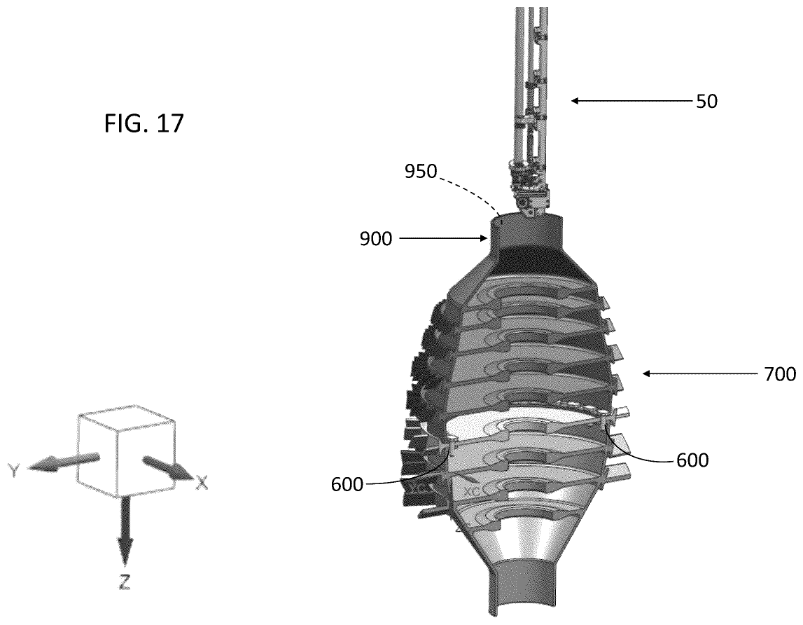

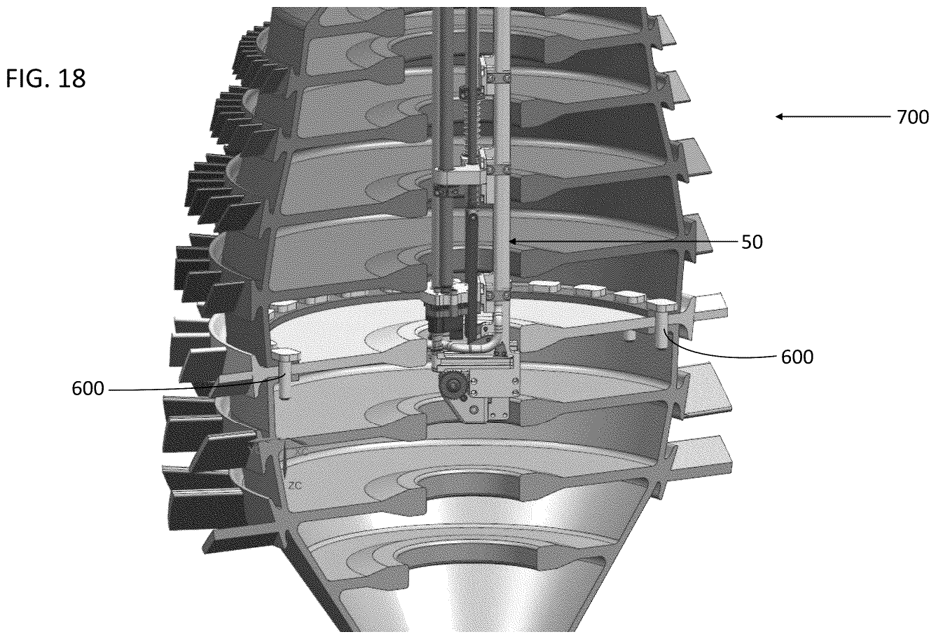

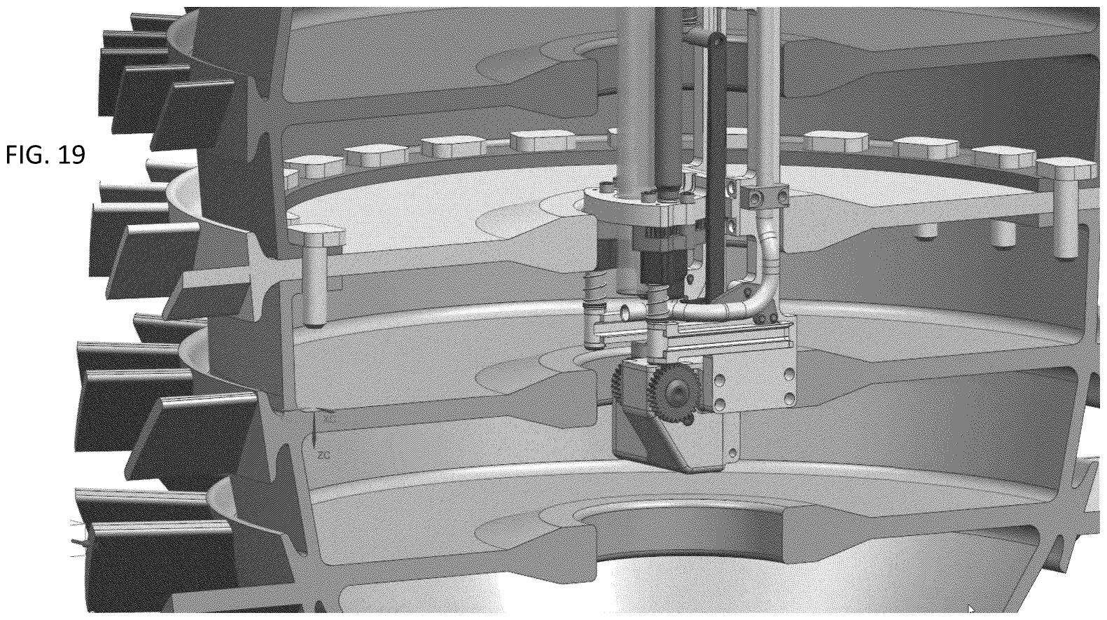

Whether assembling and/or repairing the gas turbine engine component 700, an exemplary method for assembling and/or repairing a gas turbine engine component 700 may be shown using a flowchart illustrated in FIGS. 13-16 and the illustrations of FIGS. 17-38 that correspond to each step of the method. Referring now to FIGS. 13 and 17, at an exemplary step 1000, the modular rail assembly 50 may be disposed proximate to the bore 900 of the gas turbine engine component 700. The modular rail assembly 50 may be set to the unlocked position, also known as the “inboard state”, as indicated by the position of the tracks 480 which will be proximate to the pair of rails 400. In the inboard state, the tracks 480 are not yet deployed and extended so that modular rail assembly 50 may be disposed within the opening 950 of the bore 900. Referring now to FIGS. 13 and 18, at an exemplary step 1100, the modular rail assembly 50 may be disposed within the bore 900 of the gas turbine engine component 700. Referring now to FIGS. 13 and 19, at an exemplary step 1200, the modular rail assembly 50 may reach an intended position within the bore 900 of the gas turbine engine component 700. At the intended position, the additional pair of tracks 480 of the modular rail assembly 50 may be at a rest position.

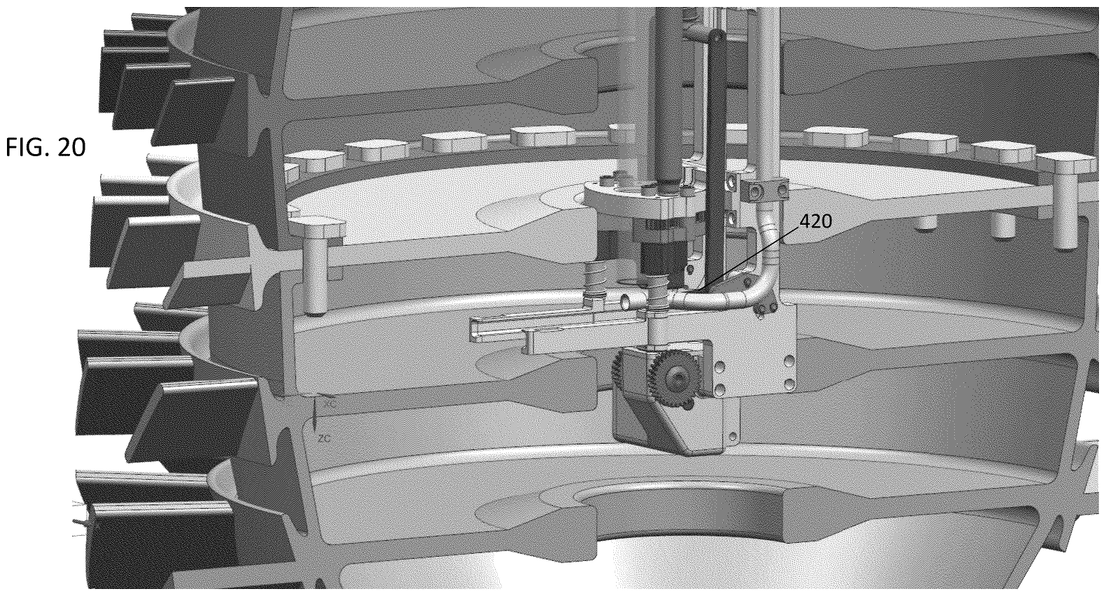

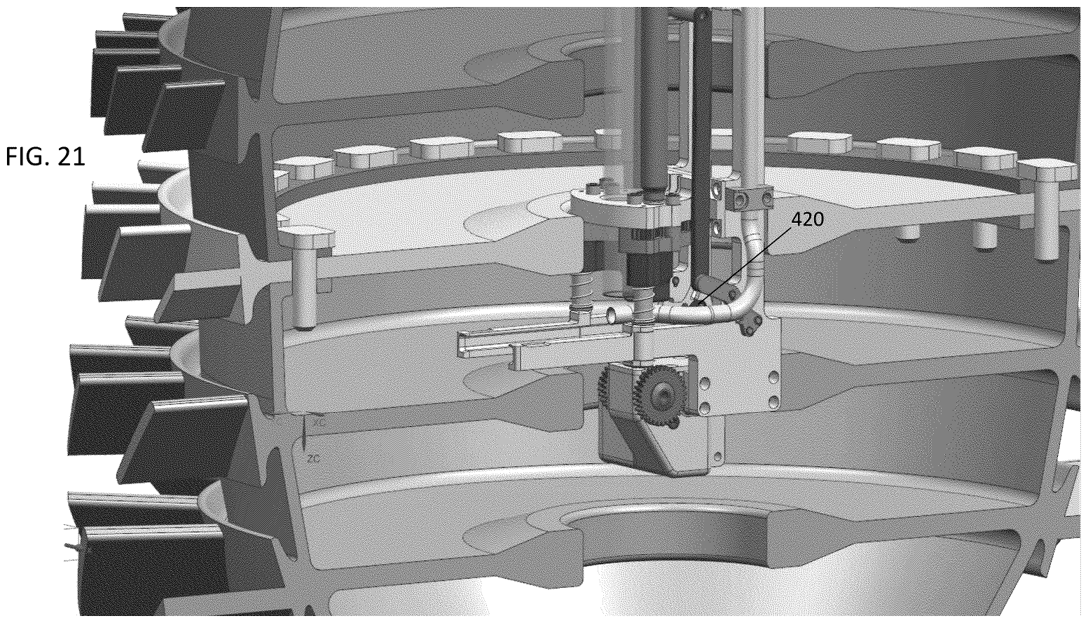

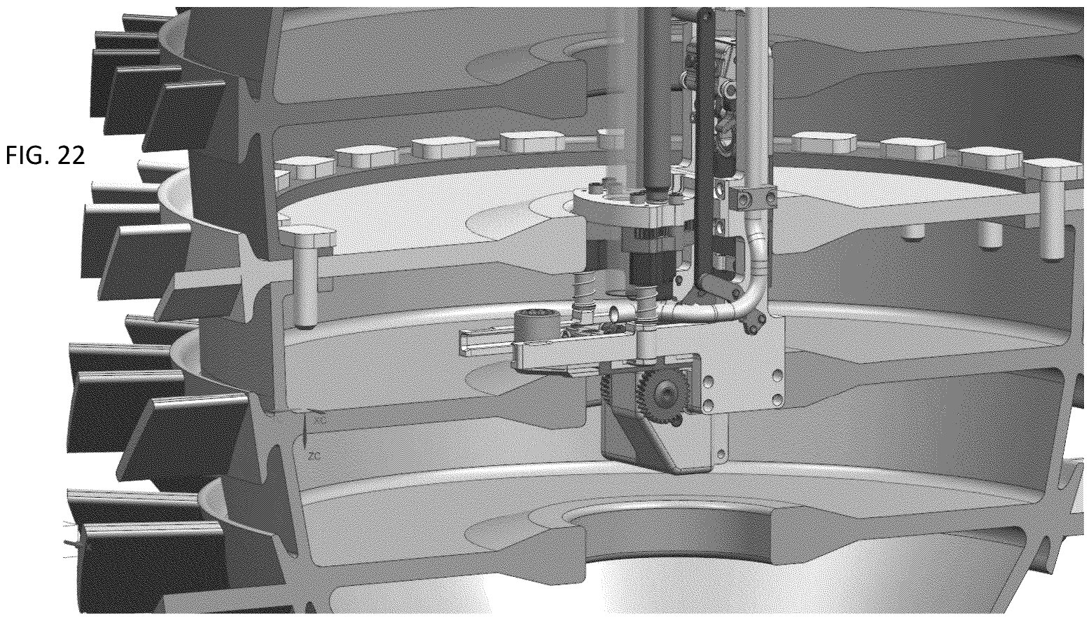

Referring now to FIGS. 13 and 20, at an exemplary step 1300, the additional pair of tracks 480 may be rotatably extended from a rest position starting in and from the −y plane, sweeping laterally across the −x plane to the +x plane, and coming to rest in the +y plane. To rotatably extend the additional tracks 480, track extension control rod 438 can be rotated until the tracks 480 traverse opposite from their unlocked or inboard position to their locked or outboard state forming a continuous track with the pair of rails 400. Referring now to FIGS. 13 and 21, at an exemplary step 1400, the flexible, segmented gearbox assembly 10 may be set to an unlocked position using the release 132 in a downward action. The unlocked position can be indicated by the position of the crank 136, connecting rod 138 and rocker 142 of the tension linkage assembly. Referring now to FIGS. 13 and 22, at an exemplary step 1500, the flexible, segmented gearbox assembly 10 then may be deployed on the modular rail assembly 50 using a bayonet style installation tool (not shown) that may engage the keyhole apertures 126a, 126b. The driven gears 477 of the radial motion gearbox assembly 465 may engage the flexible, segmented gearbox assembly 10. At that moment, the flexible, segmented gearbox assembly 10 may travel along the tracks 404, guided by and with the assistance of the bayonet style installation tool (not shown), and may engage the additional tracks 480. At the point the flexible, segmented gearbox assembly 10 engages the additional tracks 480, the bayonet style installation tool (not shown) may be disengaged from the assembly 10 at the apertures 126a, 126b.

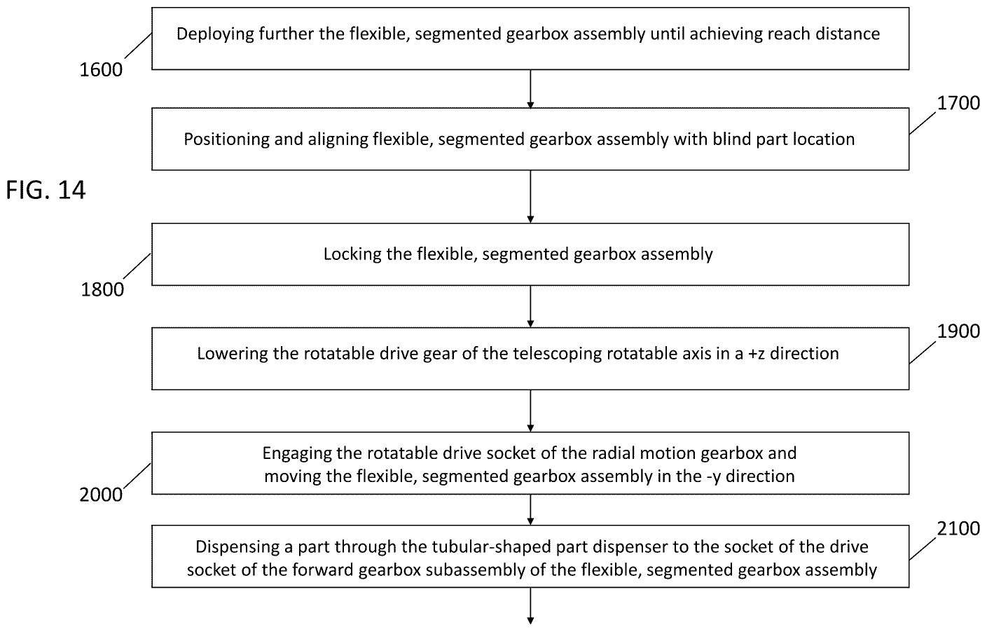

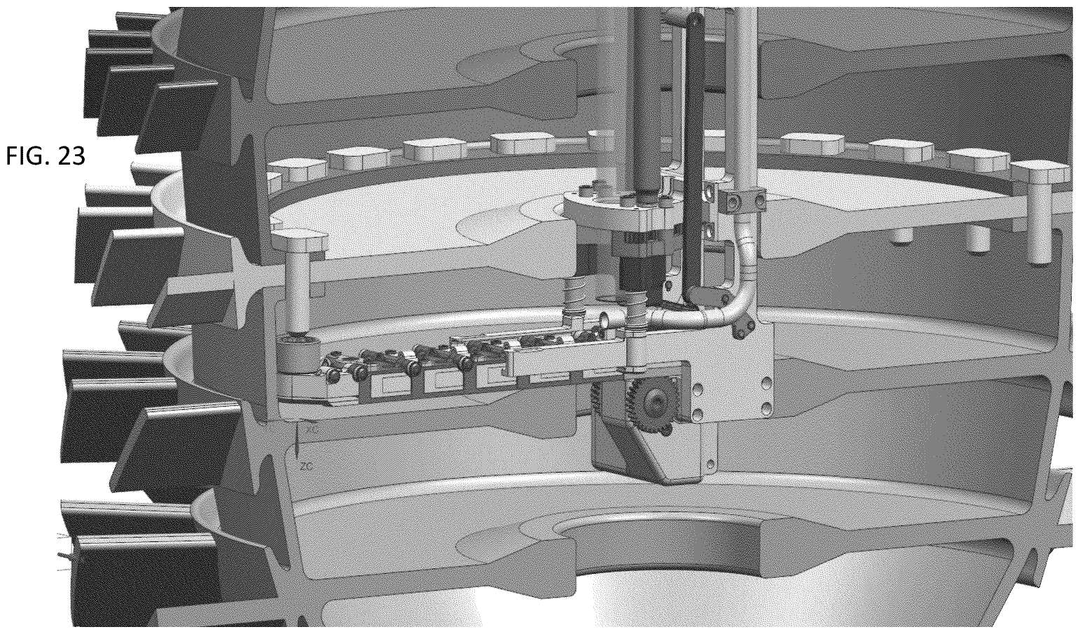

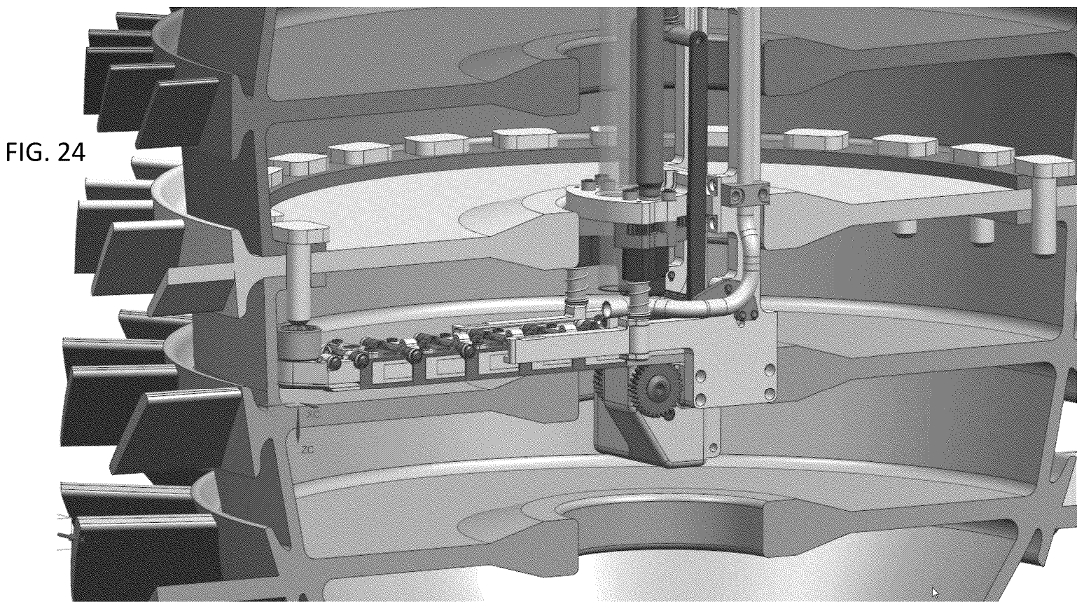

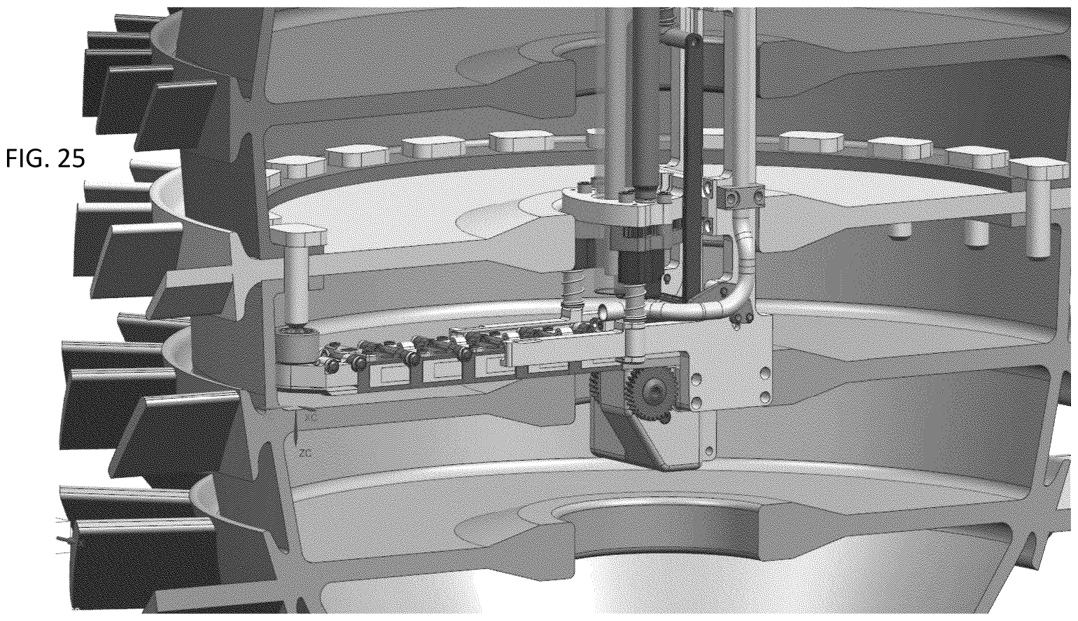

Referring now to FIGS. 14 and 23, at an exemplary step 1600, the flexible, segmented gearbox assembly 10 may travel in the +y direction and extend beyond the additional tracks 480 until achieving the distance of the reach 800. Once achieving the reach 800, the drive socket 188 of the flexible forward gearbox subassembly 300 may be positioned proximate to and aligned with the blind part location 600 at an exemplary step 1700. Referring now to FIGS. 14 and 24, at an exemplary step 1800, the flexible, segmented gearbox assembly 10 again may be reset to the locked position 413 as discussed above. Referring now to FIGS. 14 and 25, at an exemplary step 1900, the torque interface 453 of the telescoping rotatable axle 451 may be lowered in a +z direction.

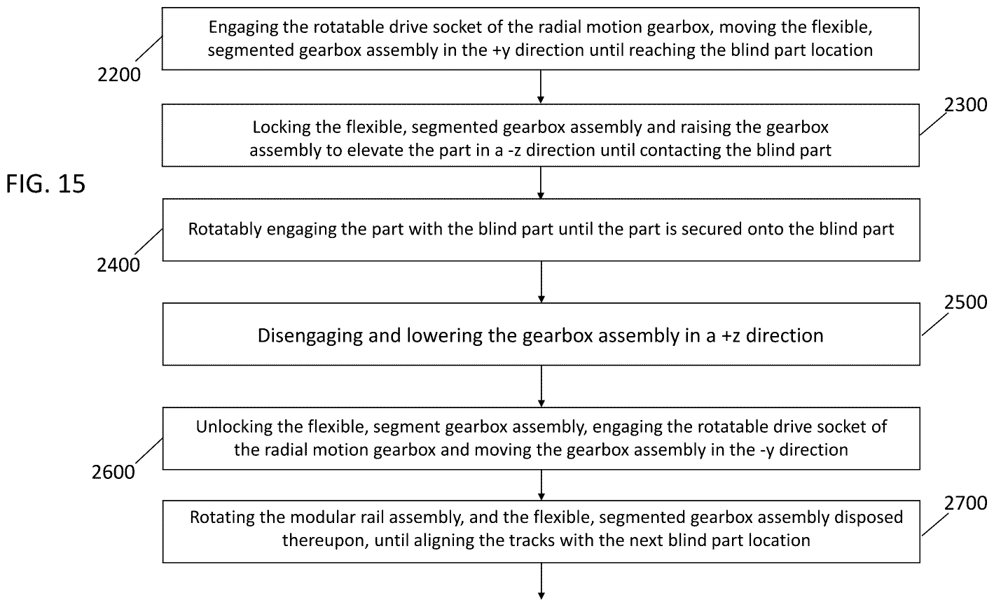

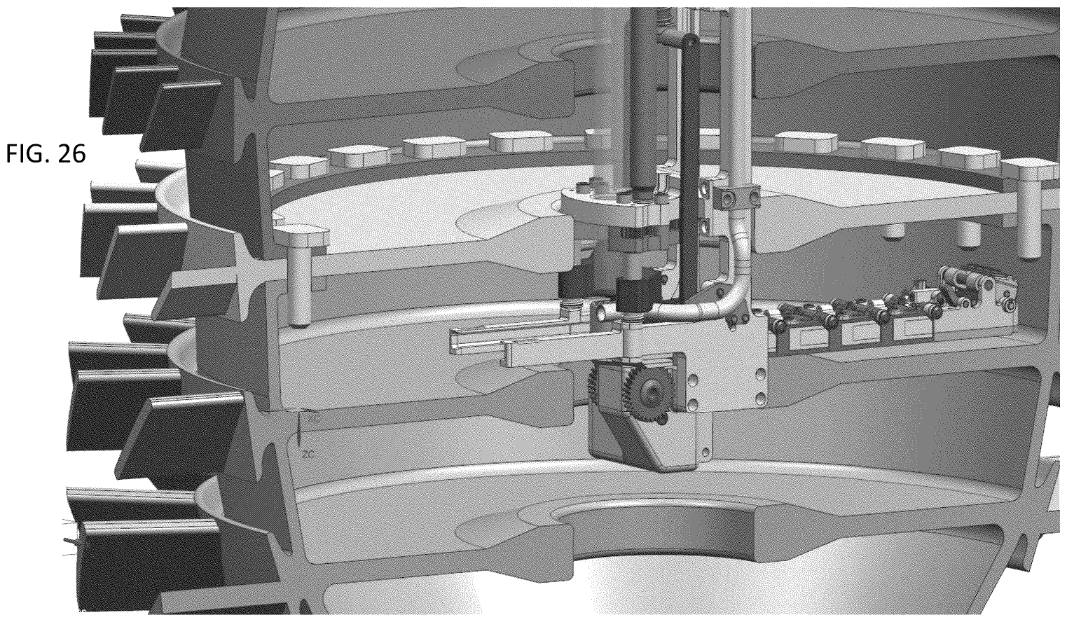

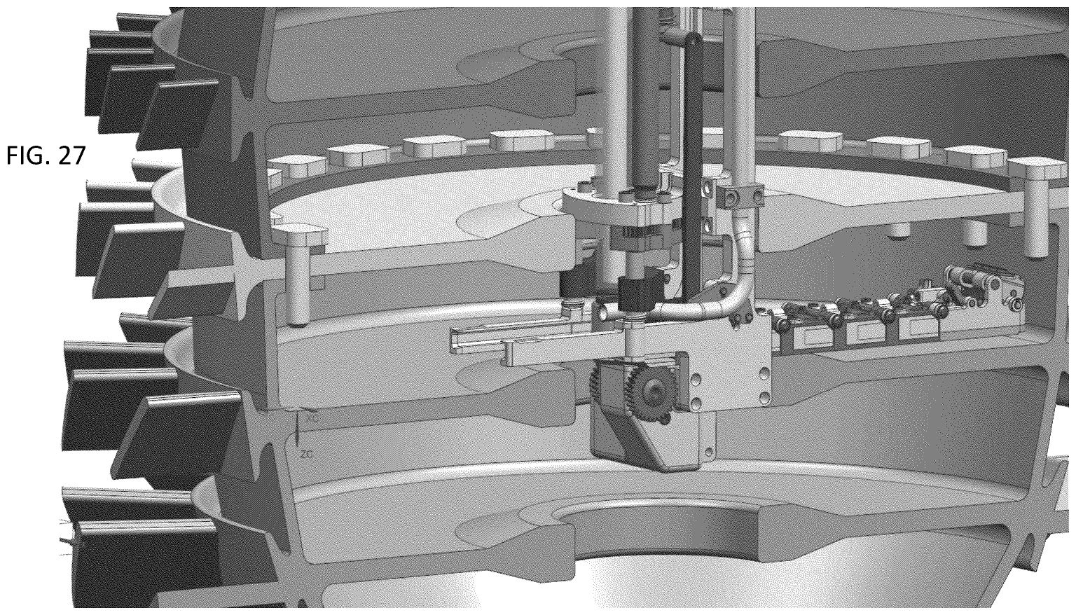

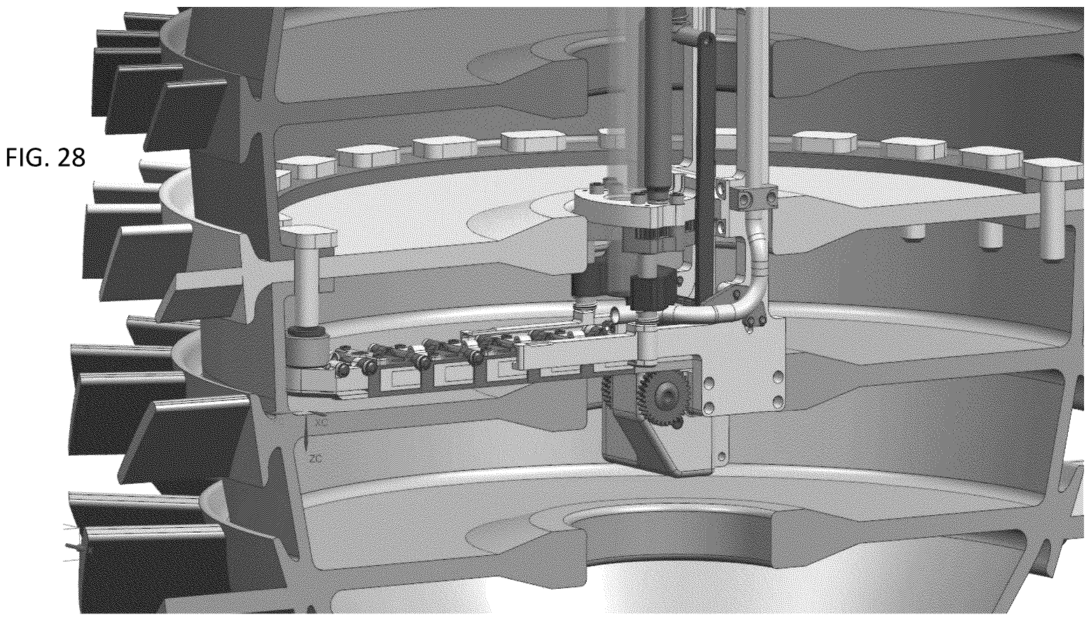

Referring now to FIGS. 14 and 26, at an exemplary step 2000, the torque interface 453 of the telescoping rotatable axle 451 may engage the rotatable drive socket 463 of the radial motion gearbox 465. The radial motion gearbox 465 may engage the radial motion gear train disclosed therein, which in turn may engage the flexible, segmented gearbox assembly 10 along the tracks 467 and additional tracks 480. As a result of said engagement, the flexible, segmented gearbox assembly 10 then may travel in the −y direction until reaching another rest position 485. Referring now to FIGS. 14 and 27, at an exemplary step 2100, once the flexible, segmented gearbox assembly 10 achieves rest position 485, a part may travel in the +z direction through the tubular-shaped part dispenser 445. When the part reaches an opening of the dispenser 445, the part, e.g., a nut, may be received by the socket 190 and contact the O-ring 191 disposed therein. Referring now to FIGS. 15 and 28, at an exemplary step 2200, the flexible, segmented gearbox assembly 10, loaded with the nut, may travel again in the +y direction along the tracks 467, and additional tracks 480 until again being positioned proximate to and aligned with the blind part location 600.

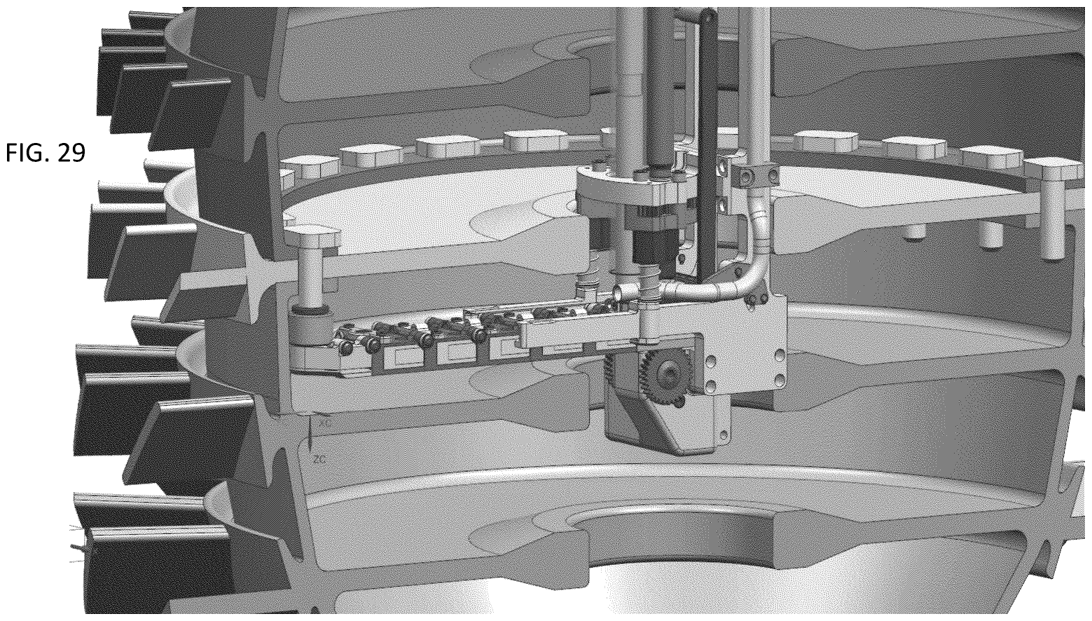

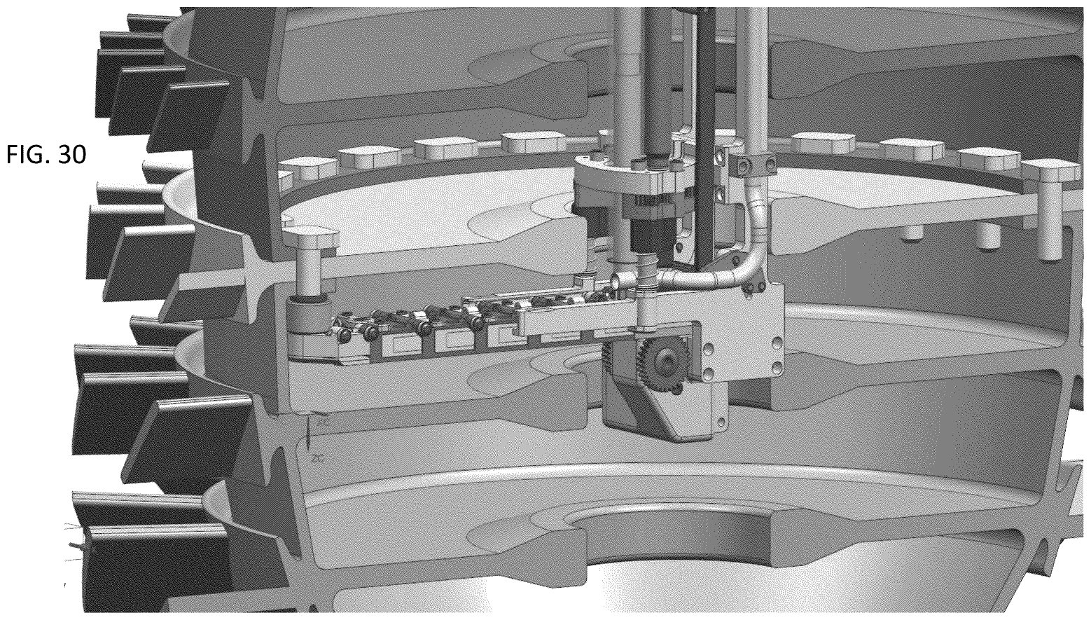

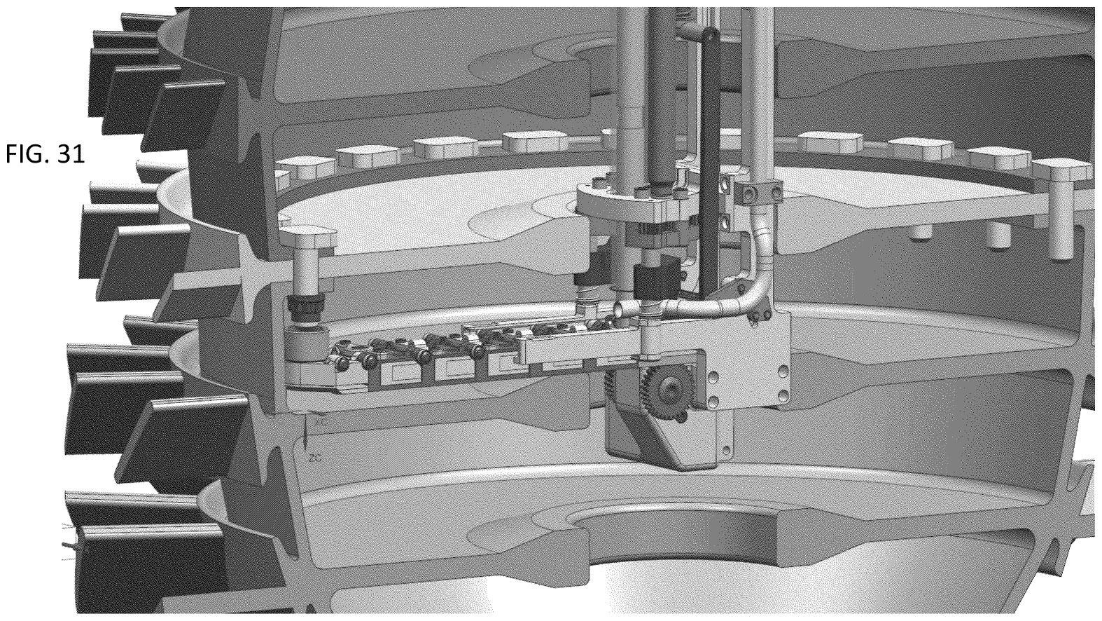

Referring now to FIGS. 15 and 29, at an exemplary step 2300, the flexible, segmented gearbox assembly 10 may be raised in the −z direction (See FIG. 29). An electrical signal (not shown) may be transmitted from a data processing unit (not shown) via the cable 156 disposed within the tubing 157, received by the magnetic rotary encoder 280 and magnet 278, and relayed back to the data processing unit. The signal may measure an angular position of the magnet 278, the gears of the gear train layout 260, and drive socket 188. In raising the gearbox assembly 10 in the −z direction, the nut disposed within the socket 190 of drive socket 188 is elevated and a distance between the blind part, e.g., a bolt, and nut may close until the nut may contact the blind part. Referring now to FIGS. 15 and 30, at an exemplary step 2400, once the nut contacts the blind part, the drive shaft 440 may be lowered to engage and rotate the drive gear 168. The data processing unit may record the torque applied using a torque transducer (not shown). The rotation angle also may be measured and recorded too using the magnetic rotary encoder 280 in combination with the magnet 278. The nut then may rotatably engage, e.g., rotatably, threadingly engage, the bolt until a desired minimum thread protrusion length of the bolt may be achieved. The desired minimum thread protrusion length may ensure that all the threads of the bolt are engaged. Referring now to FIGS. 15 and 31, at an exemplary step 2500, once the desired minimum thread protrusion length is achieved, the drive shaft 440 and drive gear 168 may disengage and, in turn, the socket 190 and drive socket 188 may disengage too. The gearbox subassembly 10 may be lowered in the +z direction until the assembly 10 may be aligned in a y direction.

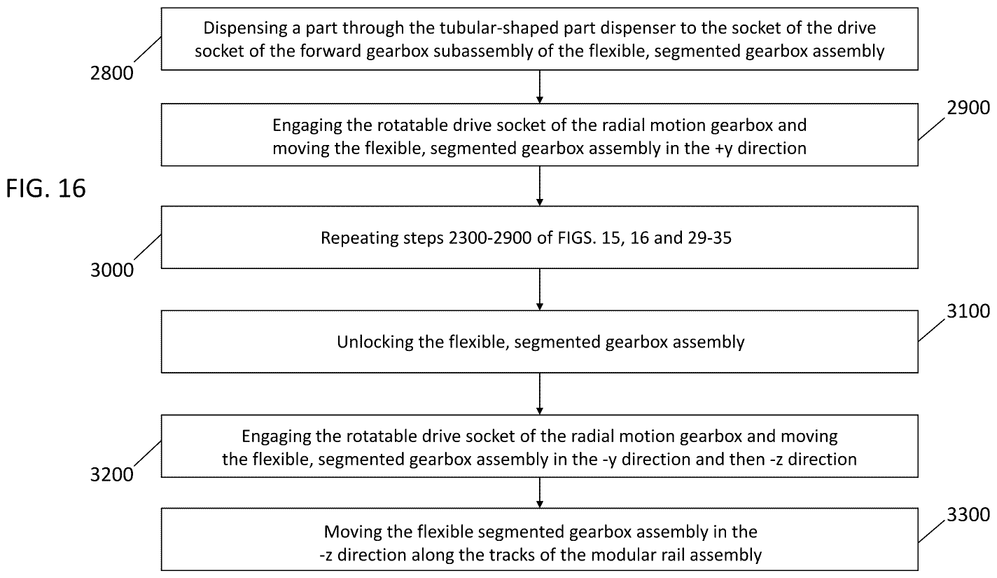

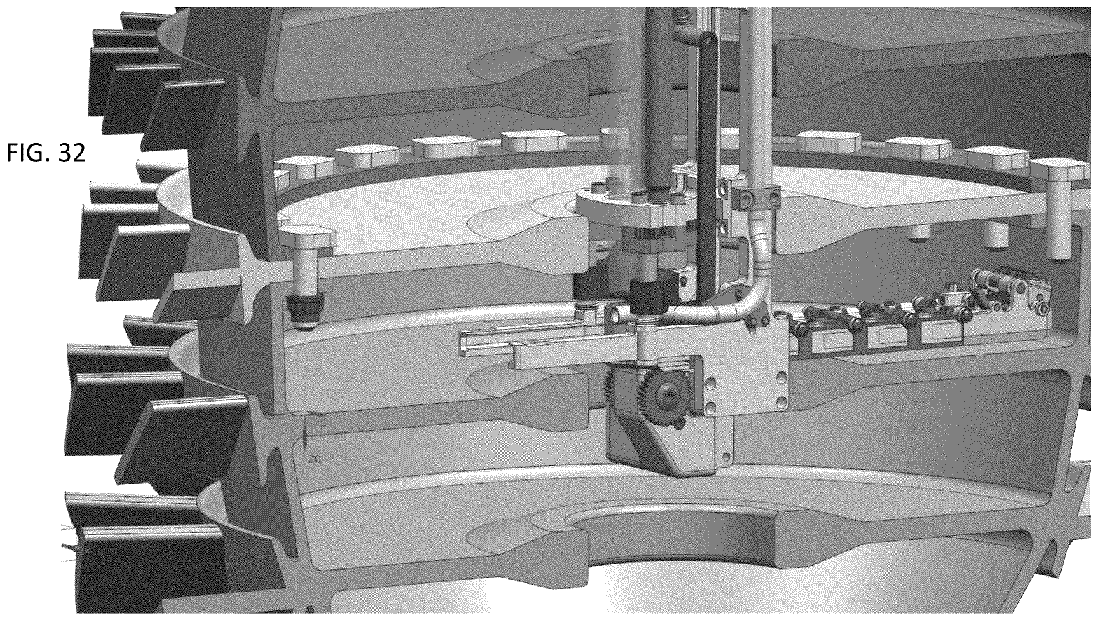

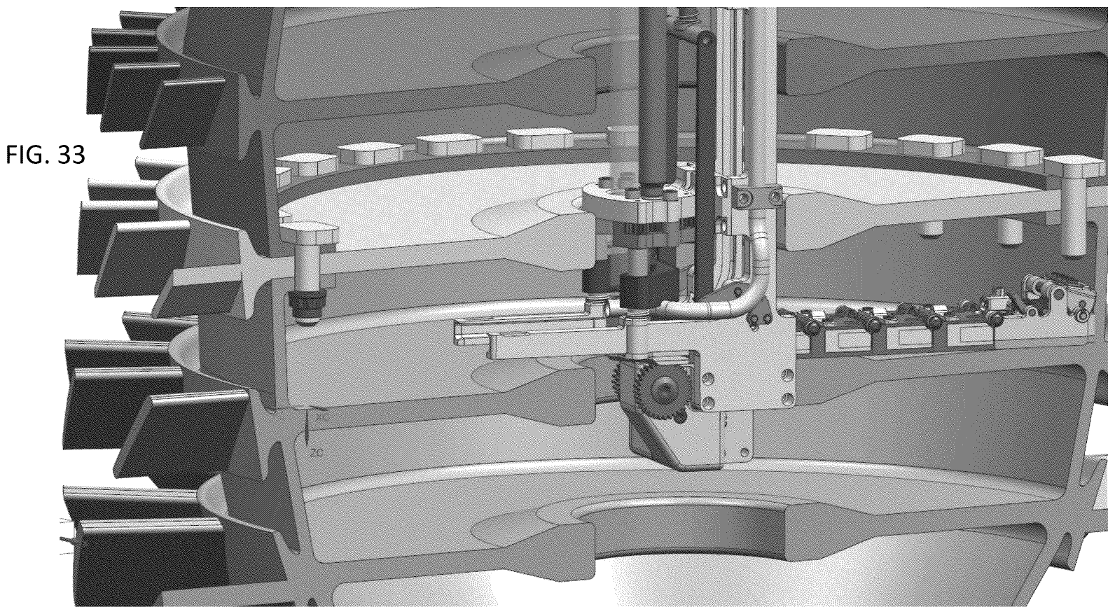

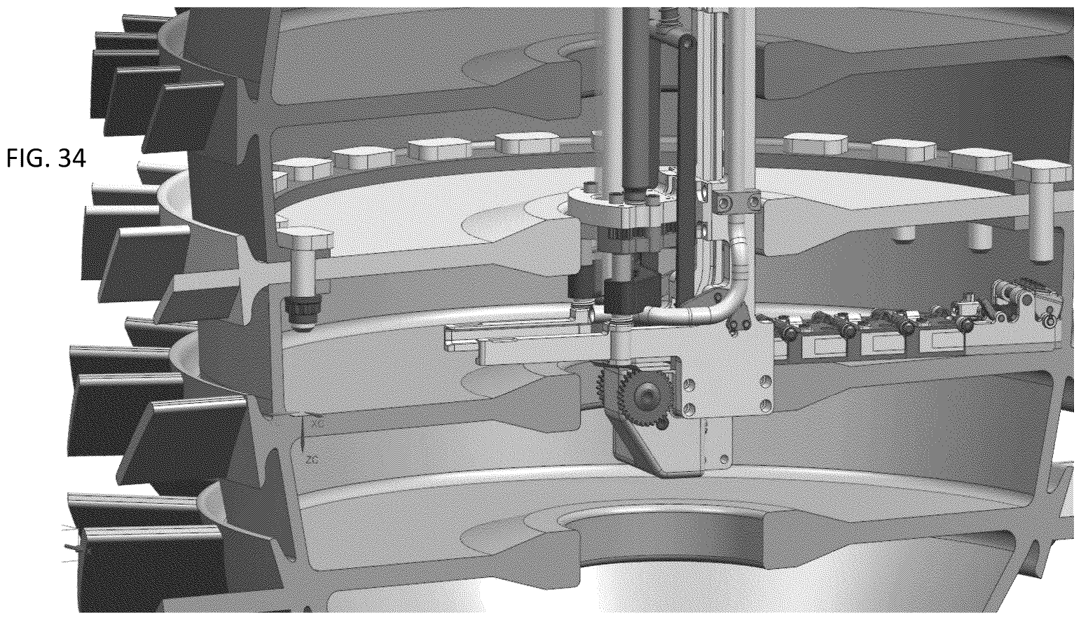

Referring now to FIGS. 15 and 32, at an exemplary step 2600, the torque interface 453 of the telescoping rotatable axle 451 again may engage the radial motion gearbox 465. The radial motion gearbox 465 again may engage the radial motion gear train disclosed therein, which in turn again may engage the flexible, segmented gearbox assembly 10 along the tracks 467, and additional tracks 480. As a result of said engagement, the flexible, segmented gearbox assembly 10 again may travel in the −y direction until reaching the rest position 485. Referring now to FIGS. 15 and 33, at an exemplary step 2700, once the flexible, segmented gearbox assembly 10 achieves the rest position 485, the modular rail assembly 50 may rotate in either a clockwise motion or a counter-clockwise motion until the tracks 467, and additional tracks 480 align in the +y direction with the next blind part location. Referring now to FIGS. 16 and 34, at an exemplary step 2800, once aligned, another a part may travel in the +z direction through the tubular-shaped part dispenser 445. Again, when the part reaches an opening of the dispenser 445, the part, e.g., a nut, again may be received by the socket 190 and contact the O-ring 191 disposed therein.

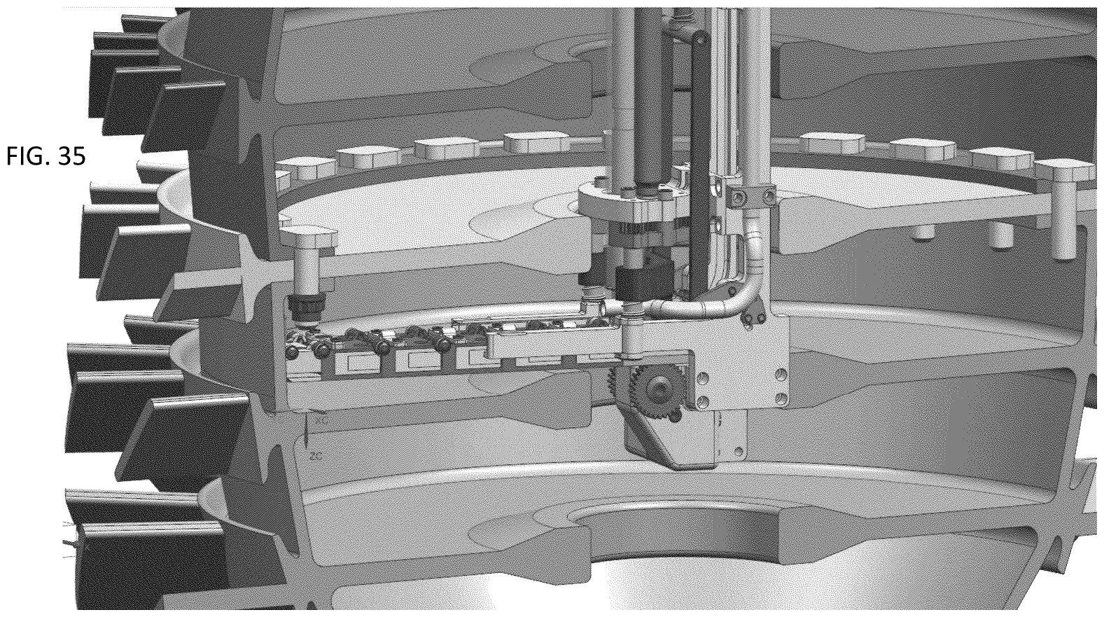

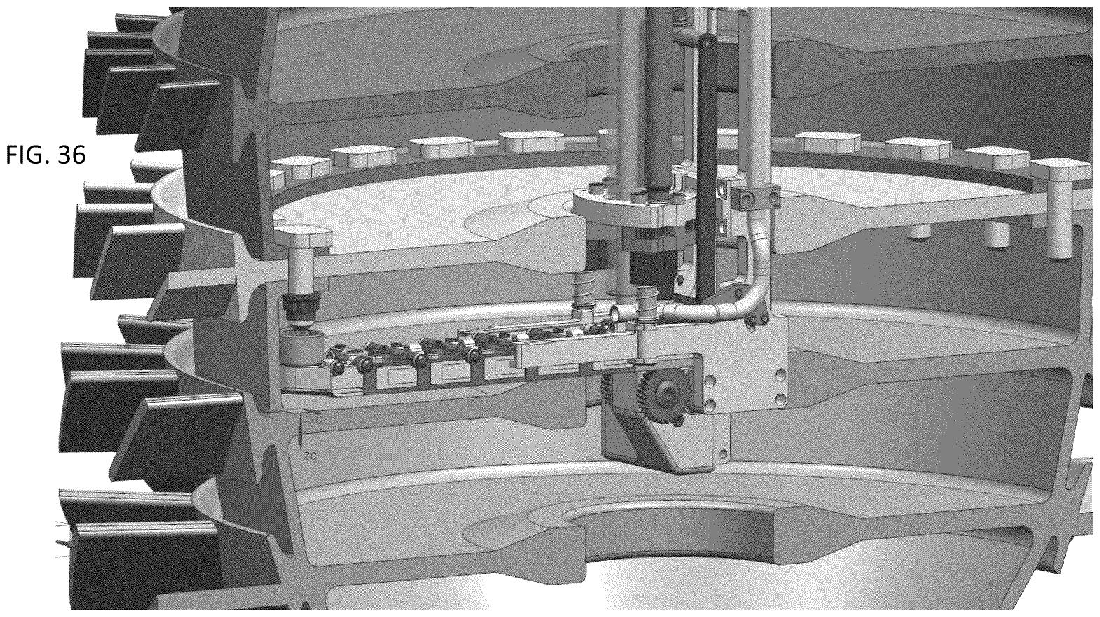

Referring now to FIGS. 16 and 35, at an exemplary step 2900, the flexible, segmented gearbox assembly 10, loaded with the nut, again may travel in the +y direction along the tracks 467, and additional tracks 480 until again being positioned proximate to and aligned with the next blind part location (See FIG. 34). Referring now to FIGS. 16 and 36, at an exemplary step 3000, once the desired minimum thread protrusion length again is achieved, the magnetic rotary encoder 280 and magnet 278 again may disengage and, in turn, the socket 190 and drive socket 188 again may disengage too. The flexible forward gearbox subassembly 300 again may be lowered in the +z direction until the subassembly 300 may be aligned in a y direction with the flexible, segmented gearbox assembly 10. Although not shown, the exemplary flexible forward gearbox subassembly 300 again may be engaged as discussed at exemplary steps 2300-2900 and illustrated in FIGS. 15, 16 and 29-35. These aforementioned steps may be repeated until each blind part at each blind part location may receive a nut rotatably, threadingly engaged therewith at a desired minimum thread protrusion length.

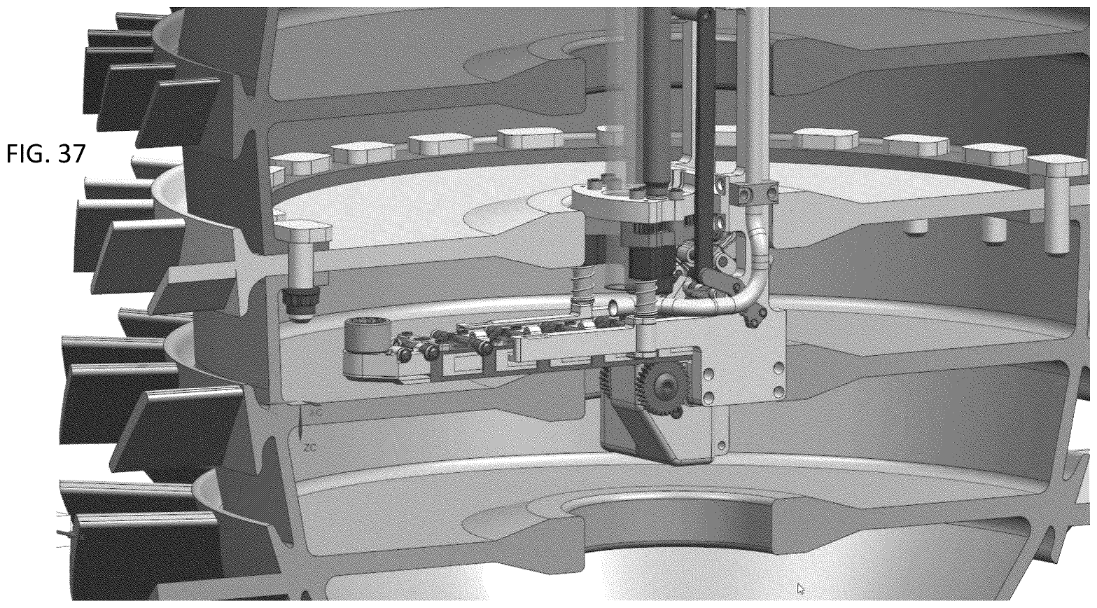

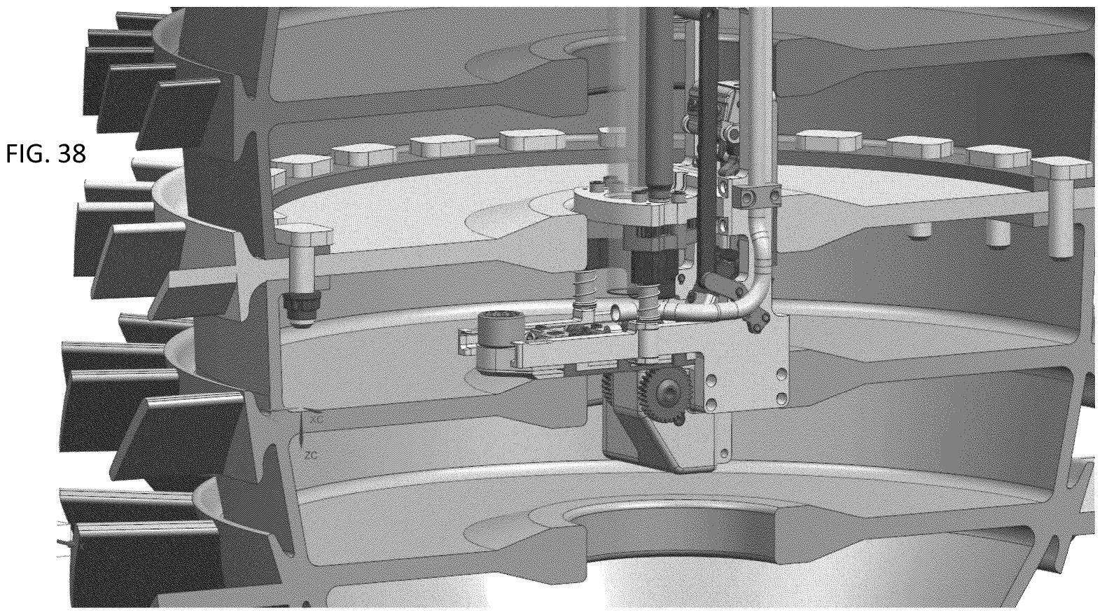

Referring now to FIGS. 16 and 37, at an exemplary step 3100, once completed, the flexible, segmented gearbox assembly 10 again may be set to the unlocked position using the release 132 in a downward action. The unlocked position can be indicated by the position of the crank 136, connecting rod 138, and rocker 142 of the tension link assembly. Referring now to FIGS. 16 and 38, at an exemplary step 3200, the rotatable drive socket 463 of the telescoping rotatable axle 451 again may engage the radial motion gearbox 465. The radial motion gearbox 465 again may engage the radial motion gear train disposed therein, which in turn again may engage the flexible, segmented gearbox assembly 10 along the tracks 467, and additional tracks 480. As a result of said engagement, the flexible, segmented gearbox assembly 10 may travel first in the −y direction until reaching and eventually engaging the tracks 404, 406 in the −z direction. Referring again to FIGS. 16 and 38, at an exemplary step 3300, the flexible, segmented gearbox assembly 10 may continue travelling in the −z direction along the tracks 404, 406 of the modular rail assembly 50. Following at least partial travel in the −z direction, the aforementioned bayonet extraction tool (not shown) again may engage the keyhole apertures 126a, 126b and may remove the gearbox assembly 10.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A deep reach torque system, comprising:
a modular rail assembly designed to receive a flexible, segmented gearbox assembly,
wherein the flexible segmented, gearbox assembly comprises:
an aft gearbox subassembly;
a mid-gearbox subassembly; and
a forward gearbox subassembly.

2. The deep reach torque system of claim 1, wherein the modular rail assembly comprises:
at least one pair of rails having at least one guide track disposed thereon;
a tubular-shaped part dispenser disposed in contact with and adjacent to the at least one pair of rails; and
a telescoping rotatable axle disposed in contact with and adjacent to the at least one pair of rails and parallel to the tubular-shaped part dispenser.

3. The deep reach torque system of claim 2, wherein the telescoping rotatable axle includes a rotatable drive gear at a distal end.

4. The deep reach torque system of claim 2, wherein the modular rail assembly further comprises a spur gear in communication with a chain and sprocket drive.

5. The deep reach torque system of claim 2, wherein the modular rail assembly further comprises a radial motion gearbox or a gearmotor.

6. The deep reach torque system of claim 1, wherein the flexible segmented, gearbox assembly further comprises a cable; and a tension band, wherein the aft gearbox subassembly is disposed in connection with the mid-gearbox subassembly, the mid-gearbox subassembly is disposed in connection with forward gearbox subassembly positioned opposite the aft gearbox subassembly, and the cable and the tension band are disposed in connection with the aft gearbox subassembly, the mid-gearbox subassembly, and the forward gearbox subassembly.

7. The deep reach torque system of claim 1, wherein the aft gearbox subassembly comprises a tension linkage assembly disposed in contact with the tension band and a bearing support housing a plain bearing capable of receiving a drive gear and permitting the drive gear to rotate therein.

8. The deep reach torque system of claim 1, wherein the mid-gearbox subassembly comprises at least one mid-gearbox segment and houses a gear train layout.

9. The deep reach torque system of claim 8, wherein the gear train layout comprises a plurality of input gears and a plurality of output gears,
the plurality of input gears comprise a drive gear and at least one pair of idler gears,
the plurality of output gears comprise at least one common gear, an encoder idler gear, and a driven gear,
the drive gear and the driven gear are disposed opposite each other and the at least one pair of idler gears, at least one common gear and the encoder idler gear are disposed between the drive gear and the driven gear,
at least one tooth of the drive gear engages at least one idler tooth of the at least one pair of idler gears,
the at least one idler tooth of the at least one pair of idler gears engages at least one common tooth of at least one common gear or at least one encoder tooth of the encoder idler gear or both at least one common tooth of at least one common gear and at least one encoder tooth of the encoder idler gear, and
the at least one idler tooth of the at least one pair of idler gears engages at least one tooth of the driven gear.

10. A method for installing a part at a blind part location within a machine, comprising the steps of:
deploying a modular rail assembly within a bore of a machine at an intended position therein;
deploying a flexible, segmented gearbox assembly on at least one pair of tracks of the modular rail assembly;
positioning and aligning the flexible, segmented gearbox assembly with at least one blind part location;
dispensing at least one part through a tubular-shaped part dispenser to a socket of a drive socket of a forward gearbox subassembly of the flexible, segmented gearbox assembly; and
rotatably engaging the at least one part with at least one blind part until the at least one part is secured on the at least one blind part.

11. The method of claim 10, further comprising repeating, until the at least one part is secured to each blind part, the following steps:
positioning and aligning flexible, segmented gearbox assembly with the next at least one blind part location;
locking the flexible, segmented gearbox assembly;
dispensing the at least one part through the tubular-shaped part dispenser to the socket of the drive socket of the forward gearbox subassembly of the flexible, segmented gearbox assembly;
raising the flexible, segmented gearbox assembly to elevate the at least one part in a −z direction and contact the at least one blind part;
rotatably engaging the at least one part with the at least one blind part until the at least one part is secured;
disengaging and lowering the flexible, segmented gearbox subassembly in a +z direction; and
rotating the modular rail assembly, and the flexible, segmented gearbox assembly disposed thereupon, until aligning the at least one pair of tracks with the next at least one blind part location.

12. The method of claim 10, wherein, prior to deploying the flexible, segmented gearbox assembly, rotatably extending at least one additional pair of tracks of the modular rail assembly using a spur gear in communication with a chain and sprocket drive.

13. The method of claim 10, after deploying the modular rail assembly, further comprising the step of unlocking a flexible, segmented gearbox assembly.

14. The method of claim 10, after deploying the flexible, segmented gearbox assembly on the modular rail, further comprising the step of deploying further the flexible, segmented gearbox assembly until achieving a reach distance.

15. The method of claim 10, after positioning and aligning the flexible, segmented gearbox assembly, further comprising the step of locking the flexible, segmented gearbox assembly.

16. The method of claim 10, after dispensing the at least one part, further comprising the step of engaging a rotatable drive socket of a radial motion gearbox or a gearmotor of the modular rail assembly and moving the flexible, segmented gearbox assembly in a +y direction.

17. The method of claim 10, after rotatably engaging, further comprising the step of disengaging and lowering the flexible, segmented gearbox assembly in a +z direction.

18. The method of claim 10, after rotating the modular rail assembly, further comprising the steps of:
dispensing a part through the tubular-shaped part dispenser to the socket of the drive socket of the forward gearbox subassembly of the flexible, segmented gearbox assembly; and
engaging a rotatable drive socket of a radial motion gearbox of the modular rail assembly and moving the flexible, segmented gearbox assembly in the +y direction.

19. The method of claim 10, wherein, after unlocking the flexible, segmented gearbox assembly, further comprising the steps of:
engaging a rotatable drive socket of a radial motion gearbox or a gearmotor of the modular rail assembly and moving the flexible, segmented gearbox assembly in the −y direction along the at least one pair of additional tracks and the at least one pair of tracks of the modular rail assembly; and
moving the flexible segmented gearbox assembly in the -z direction along the at least one pair of tracks of the modular rail assembly.

20. The method of claim 10, wherein the machine comprises a gas turbine engine comprising at least one gas turbine engine component.
